(19) United States
(12) Patent Application Publication
(10) Pub. No.: US 2012/0310764 A1
(43) Pub. Date: Dec. 6, 2012

(54) DESIGNING ONLINE DEALS LEVERAGING COLLECTIVE BUYER PURCHASING POWER IN ONLINE MARKETPLACE

(76) Inventors: Michael Sinsheimer, Charlotte, NC (US); Charlie Johnson, Newton, MA (US); Daniel Werb, Newton, MA (US)

(21) Appl. No.: 13/488,305

(22) Filed: Jun. 4, 2012

Related U.S. Application Data
(63) Continuation-in-part of application No. PCT/US12/40644, filed on Jun. 3, 2012.
(60) Provisional application No. 61/615,044, filed on Mar. 23, 2012.
(60) Provisional application No. 61/492,887, filed on Jun. 3, 2011.
(60) Provisional application No. 61/615,044, filed on Mar. 23, 2012.
(60) Provisional application No. 61/492,887, filed on Jun. 3, 2011.

(51) Int. Cl. G06Q 30/06

(52) U.S. Cl. 705/26.2

(57) ABSTRACT

A market system in which buyers and sellers design deals for goods and services, and buyers attain discounts by leveraging their collective purchasing power. Buyers or sellers can design a new deal (“proposed deal”), which is then broadcasted to other system users, inviting buyers to join the purchasing pool and informing relevant sellers of a possible business opportunity. The seller meets contractual terms with the purchasing pool or a segment of the purchasing pool (“deal acceptance”) at which point transactions are executed at the designated price cut (“deal consummation”). The system facilitates the processes of initiating the right deal at a realistic discount, accumulating group-buying power, negotiating terms, and closing the deal. The system also registers buyer and seller information, monitors transactional and browsing history, and records various rates of conversion from deal participation to actual purchases. This data is analyzed and available as an informational service to market participants.

### CROSS-REFERENCE TO RELATED APPLICATION

The present application is a nonprovisional application of, and claims priority under 35 U.S.C. §119(e) to, U.S. patent application Ser. No. 61/615,044, filed Mar. 23, 2012, and U.S. patent application Ser. No. 61/492,887, filed Jun. 3, 2011, which applications are hereby incorporated herein by reference; the present application also is a continuation-in-part patent application of, and claims priority under 35 U.S.C. §120 to, international patent application serial no. PCT/US12/40644, designating the United States and filed in English on Jun. 3, 2012, which international application and any publication thereof is hereby incorporated herein by reference, and which international application for purposes of the United States is a nonprovisional application of, and claims priority under 35 U.S.C. §119(e) to, U.S. patent application Ser. No. 61/615,044, filed Mar. 23, 2012, and U.S. patent application Ser. No. 61/492,887, filed Jun. 3, 2011.

### INCORPORATION BY REFERENCE

The disclosure of U.S. patent application Ser. No. 61/492,887 is contained in Exhibit A of the Appendix, and the disclosure of U.S. patent application Ser. No. 61/615,044 is contained in Exhibit B of the Appendix, which Appendix is incorporated herein by reference.

### COPYRIGHT STATEMENT

All of the material in this patent document, including computer program listing that may be included in an Appendix, if any, is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### COMPUTER PROGRAM LISTING

Submitted concurrently herewith via the USPTO's electronic filing system, and incorporated herein by reference, are computer program files including instructions, routines, and/or other contents of several computer program. A table setting forth the name and size of each file included in the computer program listing is included below.

| | | Size in | |
|---|---|---|---|
| File Name | Creation Date | Bytes | Description |
| readme.txt | 3/23/2012 - 4:37 PM | 2,583 | instructions |
| ascify.txt | 9/27/2010 - 3:50 PM | 37,473 | assembly |
| | | | source code |
| FLASH-ZI.TXT | 3/23/2012 - 4:31 PM | 15,060,172 | program source |

A first of these files, “readme.txt”, contains instructions for utilizing a second of the files “ascify.txt” to extract information from the remaining file. This remaining file is a compressed binary file that has been converted to ASCII format. This file can be converted back to binary format utilizing an assembly conversion program source code for which is contained in “ascify.txt”. The readme file includes instructions for compiling and running this conversion program, as well as instructions for converting the other text files to compressed, binary files. The compressed, binary files include source code configured for use on a Linux platform running Apache 2.0 which supports PHP Version 5.1.6, together with MySQL client version 5.0.95.

### BACKGROUND OF THE INVENTION

The present invention generally relates to systems, methods and apparatus for facilitating the exchange of goods and services between buyers and sellers in an online marketplace. As used herein, “items” means a good, service, or both that is provided to a buyer by a seller in connection with a purchase.

Group-buy systems are currently in vogue, with companies like Groupon and LivingSocial drawing significant press. By accumulating buyer-volume and harnessing group-buying power, these companies succeed in securing discounts for buyers and providing sellers and local merchants with a greater level of exposure and market access. However, these deals are initiated by sellers and must be approved by the system administrators, which represents a gateway between buyers and sellers. Because of this gateway, the market is not truly open. The most glaring limitation of this closed system is that buyers basically are passive participants.

Accordingly, it is believed that a need exists for improvement in such systems. This, and other needs, are addressed by one or more aspects of the present invention. Indeed, it is believed that in at least one preferred embodiment of the invention, a market system is provided having greater openness in which buyers and sellers both propose discounted deals and vie for each other's business; system administrators play a more passive role in which they preferably facilitate interaction, share data, and provide analytical services.

### SUMMARY OF THE INVENTION

The present invention includes many aspects and features. Moreover, while many aspects and features relate to, and are described in, the context of buyers and sellers, the present invention is not limited to use only in this context, as will become apparent from the following summaries and detailed descriptions of aspects, features, and one or more embodiments of the present invention.

In a broad aspect of the invention, buyers and sellers design deals for goods and services, and buyers attain discounts by leveraging their collective purchasing power. In particular, a buyer or seller designs a new deal (“proposed deal”), which is then broadcasted to other system users, inviting buyers to join the purchasing pool and informing relevant sellers of a possible business opportunity. When a seller meets contractual terms with the purchasing pool or a segment of the purchasing pool (“deal acceptance”), at which point transactions are executed at the designated price cut (“deal consummation”). The system facilitates the processes of initiating the right deal at a realistic discount, accumulating group-buying power, negotiating terms, and closing the deal. The system also registers buyer and seller information, monitors transactional and browsing history, and records various rates of conversion from deal participation to actual purchases. Preferably, this data is analyzed and made available in an informational service to market participants.

In an aspect of the invention, a method of facilitating the exchange of goods and services between buyers and sellers in an electronic marketplace, comprising: providing an electronic marketplace which is accessible by users through Internet communications and through which (i) users propose deals, (ii) users review proposed deals, (iii) users comprising buyers join proposed deals, and (iv) users comprising sellers accept proposed deals; and receiving and storing sufficient user information to effect a transfer of electronic funds from a financial account of one user to a financial account of another user for an accepted deal to which the users are parties.

In a feature of this aspect, the users comprising buyers join proposed deals by committing to the deals through the electronic marketplace.

In another feature, users comprising buyers propose deals which users comprising sellers accept. A proposed deal may require a specified minimum number of users comprising buyers who must join the proposed deal in order for the proposed deal to be accepted by a user comprising a seller.

In another feature, users comprising buyers are each able to specify, through the electronic marketplace, reserve criteria for a proposed deal which, if the respective reserve criteria of such a buyer is met, results in such buyer joining the proposed deal. Preferably, users comprising sellers are able to view, through the electronic marketplace, reserve criteria of respective buyers for a proposed deal, and users comprising sellers are able to bid, through the electronic marketplace, on a proposed deal.

In another feature, the provided electronic marketplace is accessible by users through a website.

In another feature, the provided electronic marketplace is accessible by users through a mobile app.

In another aspect, a method of facilitating the exchange of goods and services between buyers and sellers in an online marketplace comprises providing a website accessible on the Internet through which (i) users propose deals, (ii) users review proposed deals, (iii) users comprising buyers join proposed deals, and (iv) users comprising sellers accept proposed deals; and receiving and storing sufficient user registration information to effect the transfer of electronic funds from a financial account of one user to a financial account of another user for an accepted deal to which the users are parties.

In features of this aspect, the users comprising buyers join proposed deals by committing to the deals through the website; and users comprising buyers propose deals which users comprising sellers accept. Furthermore, a proposed deal may require a specified minimum number of users comprising buyers who must join the proposed deal in order for the proposed deal to be accepted by a user comprising a seller; and users comprising buyers preferably are each able to specify, through the website, reserve criteria for a proposed deal which, if the respective reserve criteria of such a buyer is met, results in such buyer joining the proposed deal. Moreover, users comprising sellers preferably are able to view, through the website, reserve criteria of respective buyers for a proposed deal; and users comprising sellers are able to bid, through the website, on a proposed deal.

In another feature, the step of providing a website accessible on the Internet comprises sending electronic communications over the Internet to the users and receiving electronic communications over the Internet from the users.

In another feature, a committed buyer is able to leave a proposed deal to which the committed buyer has joined prior to acceptance by a seller by withdrawing the commitment.

In another feature, users comprising buyers express intent to join deals through the website and, preferably, users comprising sellers view expressions of intent to join deals by users comprising buyers, and users comprising buyers who have expressed intent to join a deal are able to join such deal after the deal has been accepted by a user comprising a seller.

In yet another feature, each user is able, through the provided website, to promote a proposed deal on a social networking site at which the buyer has an account.

In another feature, each user is able, through the provided website, to send information about a proposed deal by email.

In another feature, a user proposes a deal by creating a deal, comprising the steps of specifying both a minimum number of users comprising buyers who must join the deal in order for deal to be accepted and a maximum number of users comprising buyers who may join the deal in order for the deal to be accepted; specifying an expiration date of the deal; specifying a category associated with a good or service of the deal; specifying a branded good or service of the deal; specifying a geographical area in which a good or service of the deal is limited; specifying a retail value of a good or service of the deal; specifying a discount to a retail value of a good or service of the deal; specifying tiered discounts based on the number of users comprising buyers who have joined the deal; specifying an immediate sale price of a good or service of the deal; specifying users comprising sellers for soliciting acceptance of the deal; specifying whether unspecified sellers are permitted to accept the deal; and any combination thereof.

Another aspect includes a system that implements any of the foregoing aspects.

In another aspect of the invention, a market system connects users comprising prospective buyers and prospective sellers and enables transactions of items between them, wherein the system allows buyers to join purchasing pools and achieve discounts.

In a feature, the system enables sellers to capture segments of purchasing pools.

In another feature, users interact in and with the market system via a central portal that is custom tailored for individual users based on their account information, thus matching them with appropriate market information and alerts. Preferably, users perform all market and system actions via the portal (or via any other combination of platforms that use system databases), which is accessible on Internet and/or mobile devices. The portal may be applied to a user's personal pages and incorporated for enhancing exposure, and the data sent to the portal may be translated to other platforms or registries.

In another feature, buyers and sellers initiate deals and set deal parameters, including specifying one or more ranges of one or more specifications. Deals preferably are uniquely identified by unique deal IDs. A deal initiator preferably is alerted if a deal being created is unlikely to succeed based on, for example, past, similar deals which have been created and whether such deals have succeeded. An item catalogue preferably is provided to assist shopping and creating standardized deal listings for specific items, in part to limit redundancies and establish base pricing; and preferably catalogued items are accompanied by expected pricing indexes for different deal parameter combinations, as predicted by outcome of past deals. A deal initiator preferably is alerted if at risk of creating a redundant deal, and may be blocked from creating a redundant deal absent administrator approval. Preferably deal redundancies are evaluated based on the uniqueness of the array of deal parameters. Moreover, a deal initiator preferably is redirected to the pre-existing deal forming the basis of the redundancy and is encouraged to participate in that deal. Also preferably, the web is combed to establish base pricing, from which discount parameters of a deal may determine the reserve pricing at an absolute or fractional deduction of a base price. Moreover, in this context, “base price” is intended to mean a theoretical retail price at which an item is available without leveraging any purchasing power of a pool of buyers. The base price thus provides a frame of reference for buyers and sellers when designing a deal, for sellers when deciding whether to bid on a deal, and for buyers when deciding whether to join a deal.

Additionally, one or more preferred methods includes the step of: assisting users in creating successful deals by granting access to de-identified data regarding buyers' purchasing intentions and predilections based on their purchasing history and other recorded interests, with additional analysis and/or suggestions; the step of allowing joint deals for multiple, perhaps complementing, items from the same or different sellers (and in the latter scenario insuring that joint deals only occur if and only if every seller involved has accepted the terms); limiting a user's quota of created deals allowed in a given period based on their user rating as rated by other users; or any combination of the foregoing.

In another feature, access to information and analytics is based on varying degrees corresponding to subscription membership levels.

In another feature, deals are broadcasted and advertised, or otherwise promoted, which generally results in accumulated group buying power. The buyers and sellers may promote deals through their online social networks, including for example, Facebook and Twitter. Preferably such promotion is automatic and passive, but may be controlled and tailored for designated recipients or groups of recipients.

In another feature, deals are listed automatically based on a user's account information, including registered activity, such that deal listings are prioritized according to a scale of how well the parameters and tags of a deal match the user's data. Additionally, listings may be prioritized based on the rating of the deal creator, or deals may be listed directly as broadcasted from a particular user. Preferably, activity in the system affects the prioritization of deal listings; deal types joined or purchased may thus be prioritized over deal types ignored or removed.

In another feature, a user may act on a deal on a listing such as, for example, joining the deal's purchasing pool, removing the listing, etc., or otherwise click directly on the deal and be linked to a more comprehensive registry listing with the same, if not more, information and available actions regarding the deal.

In another feature, sellers and buyers are rated. In this context, sellers can be rated, at least initially, based on external information like, e.g., a Better Business Bureau (BBB) rating, website rating, blog commentary, etc., and after establishing a track history in the electronic marketplace, such sellers could be rated based thereafter, solely or in part, on have such history, including ratings of sellers by buyers, With respect to buyers, sellers can rate buyers. With respect to deal initiators, both buyers and sellers can provide ratings for deal initiators.

In another feature, users search for deals based on parameters and tags.

In another feature, market participants rate sellers or other deal initiators and thereby generate a rating/ranking parameter that may be factored into the prioritization of the search and alert functions in the system.

In another feature, a buyer joins a purchasing pool by committing to the deal.

Additionally, buyers may join more exclusive purchasing pools based on their subscription level (and/or achieve additional discounts in proportion to their subscription level); and buyers preferably join purchasing pools with varying levels of commitment, such as a “hard commitment” that is binding upon the deal reaching the inflection point, and a “soft commitment” that represents an expression of interest by the buyer in joining the deal but does not represent a legally binding commitment even upon the deal reaching the inflection point. A deal initiator preferably makes a soft commitment automatically upon creation of the deal.

Preferably, a buyer is able to sets the buyer's own terms—or reserve criteria—within a range specified by a deal initiator for any open-ended deal parameters when a deal is created that allows such customizations.

Preferably, a user can track ongoing, purchased, or past deals on an archive that is provided.

Preferably, users are able to interact with the system using mobile and/or Internet-enabled devices, performing all market and system actions.

Preferably, when geographical restrictions are specified for a deal, system alerts are sent to remind a user when the user comes within the applicable physical bounds of the deal. Within this context, the system preferably alerts and encourages soft-committed buyers to make a readily available purchase, if applicable.

In some implementations, similar virtual restrictions are implemented for a specified deal, and system alerts are sent to remind a user when the user comes within the applicable virtual bounds of the deal.

In some implementations, system reminders may be provided periodically, regardless of proximity triggers.

In another feature, a precise deal without open-ended parameters and a coherent purchasing pool may be matched to the best bidding seller whereby the seller gets exclusive access to the entirety of the purchasing pool.

In another feature, when the inflection point occurs any hard-committed buyers are realized and any soft-committed buyers are given a limited period of time to actually participate in the purchase.

In another feature, deal with a segmented purchasing pool, i.e., segmented with respect to open-ended parameters and custom parameters, is paired to the seller who best matches the terms of a particular pool segment or segments, such that the seller gets exclusive access to that segment or segments of the purchasing pool. Furthermore, matching a segment of a purchasing pool may not necessarily close the deal as a whole.

In another feature, the system provides data and analysis of the purchasing pool segments.

In another feature, the system includes predicting attrition given various terms as tested by a prospective seller.

In another feature, the system includes analyzing the capture rate based on matching terms of hard-committed buyers and expected soft-committed buyer yield based on the buyer data and/or the data of similar previous deals.

In another feature, the system generates demand graphs or interest graphs based on data of pool participants and their individual terms and/or by examining the variation of their individual terms.

In another feature, segments are analyzable in the form of ordered lists.

In another feature, system administrators may consolidate purchasing pools into one deal or break up a segmented pool into multiple deals.

In another feature, those sellers able to bid on a deal may be limited to a predefined set of sellers, including only a single seller.

In another feature, a deal may be opened to only bidding from solicited sellers or a deal may be open to unsolicited bidding from any applicable seller.

In another feature, a purchasing pool—whether segment or coherent—may be captured at any time after its formation in a first-come first-serve format as long as sellers match the requisite terms of the deal.

In another feature, a purchasing pool may be captured in a structured reverse auction.

In another feature, an auction is scheduled only after the auction-related terms of a deal, such as the requisite purchasing pool volume, is met.

In another feature, an auction lasts until expiration of the time period of the deal.

In another feature, a seller may capture a purchasing pool by accepting all of the specified criteria of the deal at a predetermined “immediate sale” price or discount, which may have the effect of eliminating other sellers from participating in the deal even though the other sellers have bid on the deal and are match and/or are within the specified criteria of the deal but have not yet met the immediate sale price or discount.

In another feature, the system charges an entry fee for participation in an auction.

In another feature, auction bidding occurs as a static one-time bid or in a dynamic manner.

In another feature, a seller may make multiple static bids. The static bids may apply to different purchasing pool segments (and thereby compete for different segments and capture different segments).

In another feature, buyer leadership may contact seller liaisons via the system or via registered contact information if they require term negotiation, with additional mediation available by a system administrator.

In another feature, exclusive access to a purchasing pool or a segment of a pool is auctioned or sold to interested sellers.

In other features, sellers set reserve criteria when applicable; a seller may flag a deal for future action; a seller may receive alerts on various platforms in regard to significant changes in flagged deals; and a flagged deal with specific reserve criteria may automatically attain agreement of terms with a compatible purchasing pool or pool segment.

In another feature, hard commitments result in automatic payment, from a registered account, upon a seller match in accordance with the specified deal criteria, including discount and pricing. Furthermore, hard-committed buyers are identified as entitled to the respective deal item and/or given one or various receipts and/or other confirmations proving such entitlement, upon automatic payment; and a seller is notified of the purchase and provided receipt information for identifying buyers who have automatically paid. A voucher may serve as such confirmation and, in such example, the voucher preferably is provided electronically to a buyer during deal consummation.

In another feature, the system integrates purchases with a seller's inventory; enables automated shipping; or both.

In another feature, buyers are periodically reminded of their purchases.

In another feature, if a transaction is not honored at the perceived fault of the seller, a buyer may request a refund or other recourse by submitting a complaint to the system administrators who will resolve the complaint.

In another feature, purchasing decisions and yields are recorded and are provided for predictive analysis in future deals.

In other features, a portion of each purchase is redirected to the system owners and/or other market participants as a commission; incentives are provided—like rebated commissions or rebating other costs associated with market participation—for buyers who choose hard commitments over soft commitments and the deal reaches inflection; buyers are informed of additional savings when they choose between or convert between hard and soft commitments; deal initiators or anyone particularly responsible for promoting a deal are provided commissions; wherein any expected commission, if applicable, is made transparent the impacted sellers; and any combination of the foregoing.

In another feature, sellers pursue sponsorship opportunities that allow for greater exposure; greater purchasing pool access; subsidize additional savings incentives for buyers; incentivize other action from the buyer and/or from the system in reward for sponsorship; or any combination of the foregoing.

In another feature, a point system incentive structure is provided. Such a point system may reward loyalty and/or extended use of the system.

In still other features, buyers can review any reserve criteria of a deal; a user can filter a deal according to reserve criteria; and a user can list deals by price or by other deal parameter, including those that may be open.

In still another feature, buyers are given opportunity to make second chance bids after deal expiration. In this respect, it may be attractive for a seller to re-market an expired deal to buyers who were soft-committed and did not convert to hard-committed buyers after inflection so as to rekindle the deal. To facilitate this, a seller is provided information via the system regarding buyers who did not move from soft commit to hard commit and also information about buyers who have identified a category as being of interest to which category the deal pertains.

In another feature, a deal initiator is able to view seller bids that meet the specifications of a deal and, rather than automatically accepting, e.g., the bid with the lowest price, the deal initiator is able to compare various terms of the bid and accept the ‘best’ bid meeting the deal specifications. In this context, the deal initiator may be presented with the top three bids that meet the deal specifications and prior to acceptance, the deal initiator may be able to approve or select the winning bid. For instance, the low bidder may have more onerous purchase terms than the second lowest bidder, so the deal initiator may decide to select the second lowest bidder for deal acceptance. This feature is especially applicable when one or more of the deal specifications have ranges or are otherwise open-ended.

In another feature, a deal does not necessarily expire, or the expiration is set after an extended period of time. The deal is then used to generate segmented deals based on the underlying closed deal specifications with the segments spawning based on the open deal requirements in which ranges are provided by the deal initiator. In this manner, a first pool of buyers representing a segment of the entire purchasing pool can to a transaction without the deal actually expiring. Moreover, the first pool of buyers could be as small as a single buyer. After the segment has been removed from the purchasing pool, another similar segment could form, and the process could repeat all while the base deal continues to develop.

In another feature, a seller creates an ongoing or persistent deal under which buyers join the purchasing pool after inflection. In this scenario, a single ongoing deal would have multiple segmented deal inflections and consummations, with multiple influxes of buyers, which may suit the seller better than creating a series of separate but identical deals. In a variation of this feature, a deal may renew after reaching inflection and consummation, with buyers associated with the deal but not participating in consummation automatically continuing their previous level of participation in the renewed deal.

In another aspect, a method for buyer-initiated deal making comprises the steps of: receiving, via electronic communications, data representative of a proposed deal, to buy one or more goods or services, entered by a first registered user of a deal making system via a graphical user interface of the deal making system, the first registered user being registered as a buyer, and the data representative of the proposed deal including data representative of (i) the one or more goods or services, and (ii) a bid corresponding to a price the first registered user is willing to pay for the one or more goods or services; displaying, via a graphical user interface of the deal making system, to a second registered user of the deal making system who is registered as a buyer, information regarding the proposed deal; receiving, via electronic communications, data representative of a commitment to the proposed deal entered by the second registered user of the deal making system via a graphical user interface of the deal making system; displaying, via a graphical user interface of the deal making system, to a third registered user of the deal making system who is registered as a seller, information regarding the proposed deal; and receiving, via electronic communications, data representative of seller acceptance of the proposed deal entered by the third registered user of the deal making system via a graphical user interface of the deal making system, seller acceptance indicating a willingness to provide the one or more goods or services at the price associated with the proposed deal.

In a feature of this aspect, a graphical user interface is a graphical user interface of a web page.

In another feature, a graphical user interface is a graphical user interface of a computer application. In at least some implementations, the computer application is a smartphone application.

In another feature, the received data representative of a proposed deal includes data representative of a minimum purchasing pool size requirement.

In another feature, the received data representative of a proposed deal includes data representative of a maximum purchasing pool size requirement.

In another feature, the received data representative of a proposed deal includes data representative of a price for immediate sale.

In another feature, the received data representative of a proposed deal includes data representative of an expiration date for the proposed deal.

In another feature, the received data representative of a proposed deal includes data representative of a category associated with the one or more goods or services.

In another feature, the method includes displaying a proposed deal in a deal feed interface in which is displayed a plurality of proposed deals.

In another feature, the deal making system allows a registered user to share a proposed deal via a social networking application.

In another feature, the step of receiving, via electronic communications, data representative of a commitment to the proposed deal entered by the second registered user of the deal making system via a graphical user interface of the deal making system comprises receiving data representative of a soft commitment.

In another feature, the step of receiving, via electronic communications, data representative of a commitment to the proposed deal entered by the second registered user of the deal making system via a graphical user interface of the deal making system comprises receiving data representative of a hard commitment.

In another feature, a method for buyer-initiated deal making includes the steps of: receiving, via electronic communications, data representative of a proposed deal, to buy one or more goods or services, entered by a first registered user of a deal making system via a graphical user interface of the deal making system, the first registered user being registered as a buyer, and the data representative of the proposed deal including data representative of (i) the one or more goods or services, (ii) a bid corresponding to a price the first registered user is willing to pay for the one or more goods or services, and (iii) a minimum purchasing pool size requirement; displaying, to a plurality of other registered users of the deal making system who are registered as buyers, information regarding the proposed deal; receiving, via electronic communications, data representative of a commitment to the proposed deal entered by each of the other registered users of the deal making system via a graphical user interface of the deal making system; displaying, via a graphical user interface of the deal making system, to a registered seller of the deal making system, information regarding the proposed deal; and after a number of buyer commitments to the proposed deal made meets or exceeds the minimum purchasing pool size requirement of the proposed deal, receiving, via electronic communications, data representative of seller acceptance of the proposed deal entered by the registered seller via a graphical user interface of the deal making system, seller acceptance indicating a willingness to provide the one or more goods or services at the price associated with the proposed deal.

In yet another aspect, a method for buyer-initiated deal making comprises the steps of: receiving, via electronic communications, data representative of a proposed deal, to buy one or more goods or services, entered by a first registered user of a deal making system via a graphical user interface of the deal making system, the first registered user being registered as a buyer, and the data representative of the proposed deal including data representative of (i) the one or more goods or services, (ii) a bid corresponding to a price the first registered user is willing to pay for the one or more goods or services, and (iii) a price for immediate sale which is lower than the bid; displaying, via a graphical user interface of the deal making system, to a second registered user of the deal making system who is registered as a buyer, information regarding the proposed deal; receiving, via electronic communications, data representative of a commitment to the proposed deal entered by the second registered user of the deal making system via a graphical user interface of the deal making system; displaying, via a graphical user interface of the deal making system, to a third registered user of the deal making system who is registered as a seller, information regarding the proposed deal; receiving, via electronic communications, data representative of seller willingness to provide the one or more goods or services at the bid price, entered by the third registered user of the deal making system via a graphical user interface of the deal making system; displaying, via a graphical user interface of the deal making system, to a fourth registered user of the deal making system who is registered as a seller, information regarding the proposed deal; and receiving, via electronic communications, data representative of seller willingness to provide the one or more goods or services at the price for immediate sale, entered by the fourth registered user of the deal making system via a graphical user interface of the deal making system.

In yet another aspect, a method for buyer-initiated deal making includes receiving, via electronic communications, data representative of a first proposed deal, to buy one or more goods or services, entered by a first registered user of a deal making system via a graphical user interface of the deal making system. The first registered user is registered as a buyer, and the data representative of the first proposed deal includes data representative of the one or more goods or services, a bid corresponding to a price the first registered user is willing to pay for the one or more goods or services, and a category identifier associated with the one or more goods or services. The method further includes displaying, via a graphical user interface of the deal making system, to a second registered user of the deal making system who is registered as a buyer, following login of the second registered user to the deal making system, deals associated with the category identifier based on profile information of the second registered user indicating interest in goods and services associated with the category identifier, the deals including the first proposed deal; receiving, via electronic communications, data representative of a commitment to the first proposed deal entered by the second registered user of the deal making system via a graphical user interface of the deal making system; displaying, via a graphical user interface of the deal making system, to a third registered user of the deal making system who is registered as a seller, information regarding the first proposed deal; and receiving, via electronic communications, data representative of seller acceptance of the first proposed deal entered by the third registered user of the deal making system via a graphical user interface of the deal making system, seller acceptance indicating a willingness to provide the one or more goods or services at the price associated with the first proposed deal.

In a feature of this aspect, the step of displaying, following login of the second registered user to the deal making system, deals associated with the category identifier based on profile information of the second registered user indicating interest in goods and services associated with the category identifier comprises displaying, following login of the second user to the deal making system, deals associated with the category identifier that have been created since the second registered user's last login.

In a feature of this aspect, the method further includes, after receiving data representative of a first proposed deal to buy one or more goods or services entered by a first registered user of a deal making system via a graphical user interface of the deal making system, communicating an alert to a plurality of addresses associated with registered users whose profiles indicate an interest in goods and services associated with the category identifier, the plurality of addresses including an address associated with the second registered user.

In a feature of this aspect, the method further includes determining that the third registered user has won the first proposed deal, and communicating an alert to a plurality of addresses associated with registered users whose profiles indicate an interest in goods and services associated with the category identifier.

In yet another aspect, a method of facilitating the exchange of goods and services between buyers and sellers in an online marketplace includes providing one or more user interfaces accessible via the Internet through which, users propose deals, users review proposed deals, users comprising buyers join proposed deals, and users comprising sellers accept proposed deals. The method further includes receiving and storing sufficient user registration information to effect the transfer of electronic funds from a financial account of one user to a financial account of another user for an accepted deal to which the users are parties; wherein the users comprising buyers join proposed deals by committing to the deals through the website.

In a feature of this aspect, the one or more user interfaces include one or more user interfaces of a website.

In a feature of this aspect, the one or more user interfaces include one or more user interfaces of a computer application. In at least some implementations, the computer application is a smartphone application. In at least some implementations, the computer application is a tablet application.

Additional aspects and features are disclosed in the drawings and the detailed description that follows.

Additional aspects and feature are disclosed in the Appendix.

In addition to the aspects and features of the present invention described herein, it should be noted that the present invention further encompasses the various possible combinations and subcombinations of such aspects and features. Thus, for example, any aspect may be combined with any feature in accordance with the present invention without requiring any other aspect or feature.

### BRIEF DESCRIPTION OF THE DRAWINGS

One or more preferred embodiments of the present invention now will be described in detail with reference to the accompanying drawings.

FIG. 1 schematically illustrates one or more preferred implementations of an online market system or marketplace of the present invention.

FIG. 2 schematically illustrates parameters and tags of a buyer's account maintained in one or more preferred implementations of an online market system or marketplace of the present invention.

FIG. 3 schematically illustrates parameters and tags of a seller's account maintained in one or more preferred implementations of an online market system or marketplace of the present invention.

FIGS. 4A-4B schematically illustrate input parameters and tags, and pathways, by which a buyer (FIG. 4A) or seller (FIG. 4B) creates a deal.

FIG. 5 schematically illustrates how a buyer finds deals, is alerted to deals, and joins a purchasing pool, as well as a deal list's role in those processes.

FIG. 6 schematically illustrates how a seller finds deals, is alerted to deals, and bids on a purchasing pool, as well as a deal list's role in those processes.

FIG. 7 schematically illustrates transition from inflection point to purchase.

FIG. 8 schematically illustrates deal stages in the evolution of a deal.

FIG. 9schematically illustrates an exemplary graphical user interface for creating or initiating a new deal.

FIG. 10 schematically illustrates another exemplary graphical user interface for creating or initiating a new deal.

FIG. 11 schematically illustrates another exemplary graphical user interface for creating or initiating a new deal.

FIG. 12 schematically illustrates a basic website representative of one or more preferred systems in accordance with the present invention.

FIG. 13 schematically illustrates an exemplary dashboard for a buyer a basic website representative of one or more preferred systems in accordance with the present invention.

FIG. 14 schematically illustrates an exemplary dashboard for a buyer a basic website representative of one or more preferred systems in accordance with the present invention.

FIG. 15 schematically illustrates a window that is presented that sets forth deals, i.e., the deal listing, of Deal Feed #1 of the dashboard of FIG. 13.

FIG. 16 schematically illustrates a window that is presented that sets forth deals, i.e., the deal listing, of Deal Feed #2 of the dashboard of FIG. 13.

FIG. 17 schematically illustrates a window that is presented that sets forth deals, i.e., the deal listing, of Deal Feed #3 of the dashboard of FIG. 13.

FIG. 18 schematically illustrates a window that is presented that sets forth deals, i.e., the deal listing, of Deal Feed #1 of the dashboard of FIG. 14.

FIG. 19 schematically illustrates a window that is presented that sets forth deals, i.e., the deal listing, of Deal Feed #2 of the dashboard of FIG. 14.

FIG. 20 schematically illustrates a window that is presented that sets forth deals, i.e., the deal listing, of Deal Feed #3 of the dashboard of FIG. 14.

FIGS. 21-29 schematically illustrate exemplary websites in accordance with one or more preferred embodiments of the invention.

### DETAILED DESCRIPTION

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6 with respect to the United States, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of things, “or” denotes “at least one of the things,” but does not exclude a plurality of things of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of things, “and” denotes “all of the things of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

One or more preferred embodiments relate to a system comprising an online marketplace that includes a group-buy platform. Exemplary such system and platforms may sometimes be referred to herein as FLASH PURCHASE, which is in reference to a brand adopted for services that implement one or more aspects of the invention. Additionally, sometimes proposed deals are referred to by the branded phrase “Flash Deal” or “FlashDeal”; sometimes occurrence of an inflection point is referred to by the branded phrase “Flash Point” or “FlashPoint”; and sometimes consummated deals are referred to by the branded phrase “Flash Purchase” or “FlashPurchase”. In none of these contexts is the flash-phrase intended to refer generically to the technology or any related system, method or apparatus.

### Principal Features of Some Preferred Embodiments

Briefly at the outset, the following principal features of one or more preferred embodiments of the present invention should be noted and keep in mind throughout the following discussion: buyers find or create desired discounts for sought-after items; like-minded buyers pool their purchasing power to achieve such discounts; and buyers request quotes and invite sellers to compete for their business in a reverse-auction format or other format.

In at least some preferred implementations, there are additions or variations to these features, including sellers also initiating deals; and sellers identifying and making unsolicited bids on purchasing pools that do not target them specifically but happen to relate to their business. Furthermore, in one or more preferred embodiments, the actions of market participants (i.e., buyers and sellers) are recorded and analyzed such as to facilitate future deals.

It will also be appreciated that there are different types of users in such system of the invention. Before describing such systems, an overview of the users involved with such systems, and recurring components of such systems, first is provided.

### Overview of Users: The Buyer

A first type of user in preferred systems of the invention is the buyer.

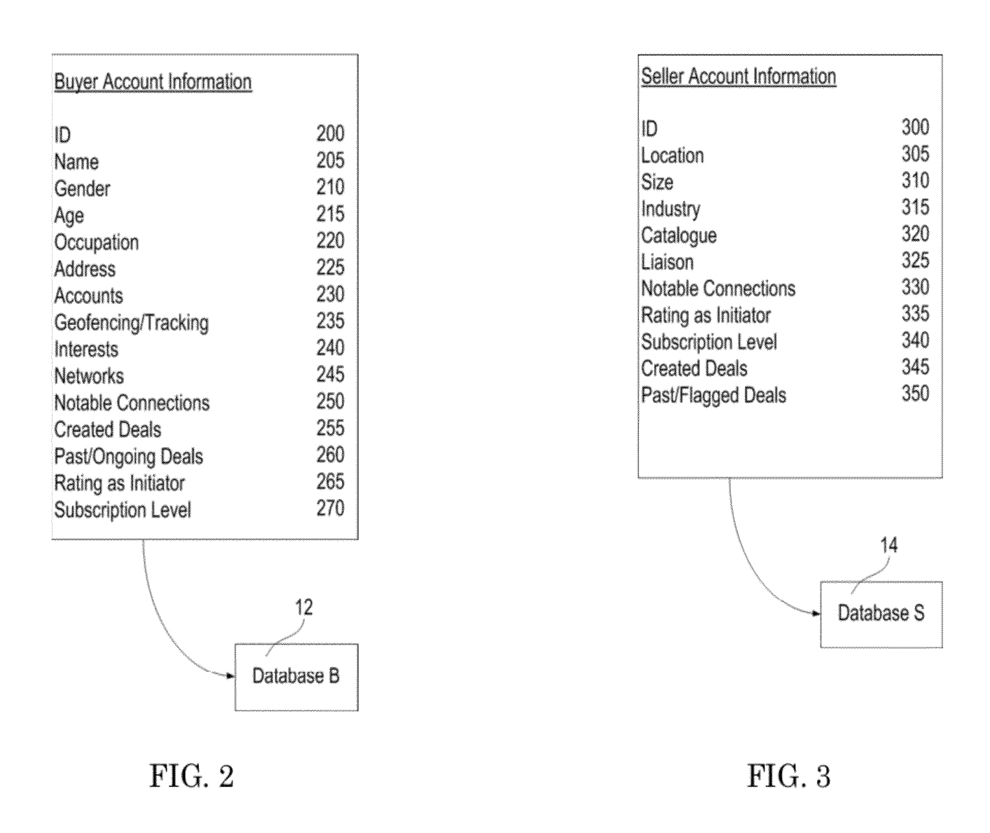

Preferably, a buyer registers a personal account in a market system, thereby providing personal and demographic disclosures into a database 12, as illustrated in FIG. 2, some of which the buyer may choose not to disclose if disclosure is optional. Exemplary data fields of such a database 12 may include: a buyer ID (unique identifying key in database); name information; gender information; age information; occupation information; address and other contact information; financial account information (such, as for example, related to payment processing and access to purchasing history); permission to enable geofencing information (for tracking location and movements via a mobile device) and for tracking system activity and other online browsing activity; item tags for interest graph (determining the kinds of items that interest a buyer—this might be done, for example, by letting a buyer enter tags, choose from a list of tags, take a survey or browse a catalogue that generates tags, or monitoring a user's browsing activity and history and assigning tags correspondingly; information related to access to online social networks and accounts (and information and disclosure necessary to integrate those networks, allowing them to talk to each other); information on affinity groups and individuals of interest (for example, a buyer might care about the activities of friends, family, or other individuals with similar tastes); information on created deals in the system; information on past purchases in the system; information on ongoing deals in the system; an initiator rating; and buyer subscription membership level information.

This foregoing information for a buyer might be captured, for example, in the following parameters illustrated in FIG. 2: an ID parameter(s) 200, a name parameter(s) 205, a gender parameter(s) 210, an age parameter(s) 215, an occupation parameter(s) 220, an address parameter(s) 225, an accounts parameter(s) 230, a geofencing/tracking parameter(s) 235, an interests parameter(s) 240, a networks parameter(s) 245, a notable connections parameter(s) 250, a created deals parameter(s) 255, a past/ongoing deals parameter(s) 260, a rating as initiator parameter(s) 265, and a subscription level parameter(s) 270.

Preferably, a buyer's activities in the market system are recorded and analyzed so as to understand their purchasing interests, make recommendations and streamline their personal experience, and calculate the likelihood that they would commit to certain kinds of purchases. With permission, buyer accounts are preferably integrated with their other online accounts and profiles, such as payment-related accounts, social media, retail sites, and any other purchasing or payment-related website that records the activity of registered users. Buyers can initiate, browse, join, and negotiate deals (and ultimately make purchases). The market system matches buyers with other buyers who together create the purchasing pool. The market system then matches the purchasing pool to sellers (or sellers) who carry the products or provide the services of interest to that purchasing pool. Whoever initiates the deal can parley with potential sellers, entrust negotiations to someone else, or design a deal in which negotiation is inapplicable to begin with.

### Overview of Users: The Seller

A first type of user in preferred systems of the invention is the seller.

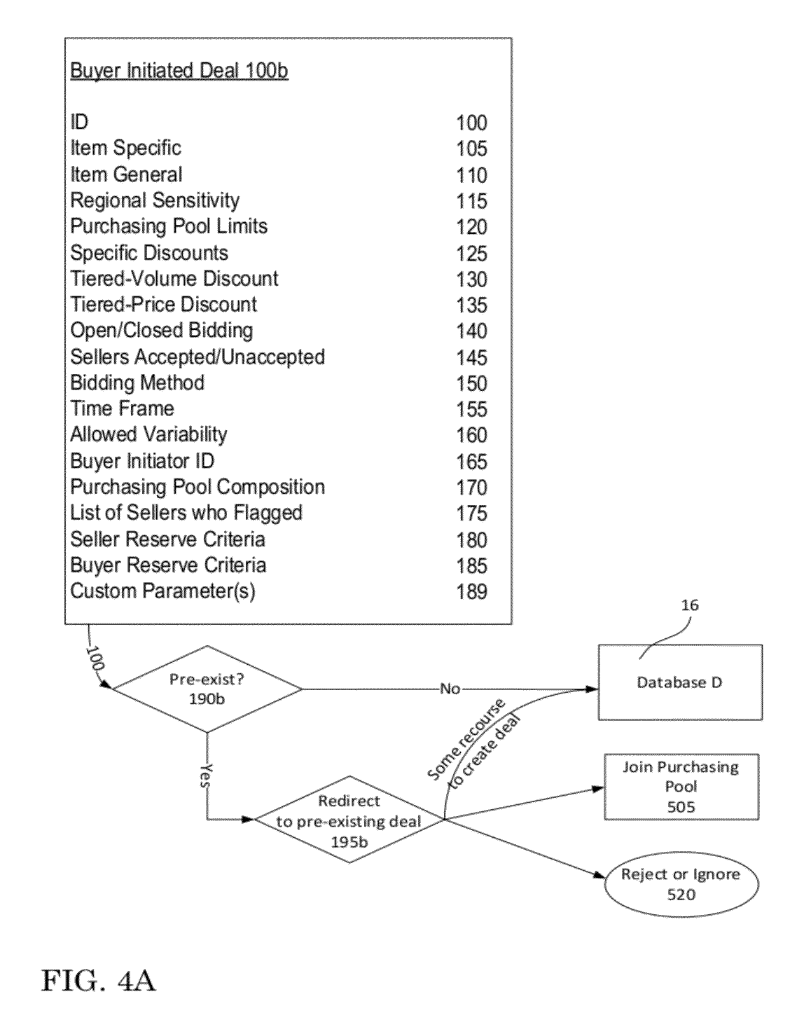

Preferably, the seller registers a business account in the system, providing information into a database 14, as illustrated in FIG. 3, some of which is generated automatically in the course of their market interactions. Exemplary data fields of such a database 14 may include: seller ID (unique identifying key in database); locations information; size information; industry information; product catalogue information; contact information for the seller's liaison with other system participants and administrators; information related to affinity groups and individuals of interest (for example, a seller might care about what their competition is offering or what their past customers are interested in buying); seller rating information; a seller subscription membership level; information on created deals; information on past purchases; and information on flagged deals.

Preferably, this information is rendered into one or more arrays of tags and parameters that facilitate the process of alerting sellers to any pertinent business opportunities. Multiple sellers can bid on a deal. Registered sellers can also use the system as a marketing platform in a variety of ways, such as creating their own deals and promoting the deal through the system.

This information might be captured, for example, in the following parameters illustrated in FIG. 3: an ID parameter(s) 300, a location parameter(s) 305, a size parameter(s) 310, an industry parameter(s) 315, a catalogue parameter(s) 320, a liaison parameter(s) 325, a notable connections parameter(s) 330, a rating as initiator parameter(s) 335, a subscription level parameter(s) 340, a created deals parameter(s) 345, and a past/flagged deals parameter(s) 350.

### Overview of Users: The Administrator

A third type of user in preferred systems of the invention is the administrator. Preferably, the administrator administers such systems and helps facilitate communication and deal making between buyers and sellers.

### Overview: Deals

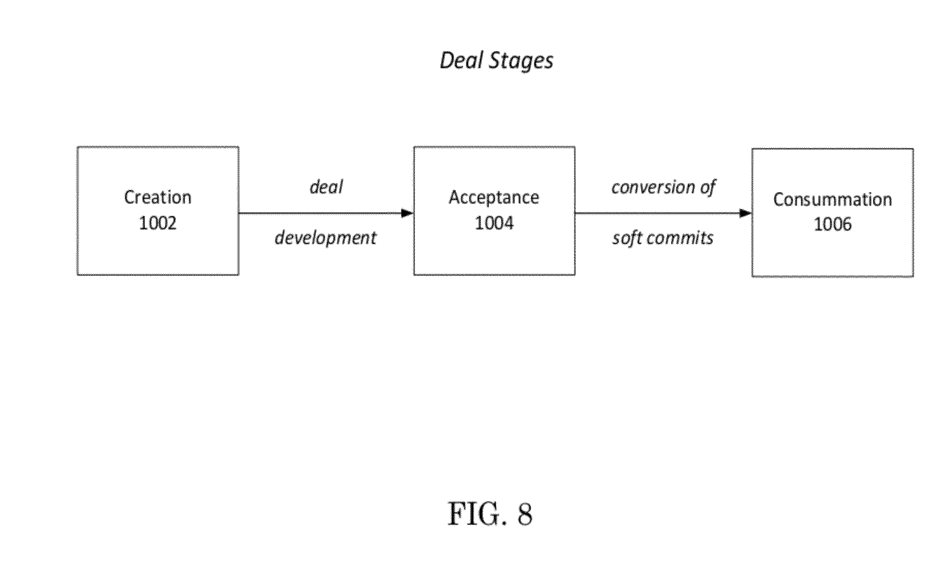

The “deal” has been referred to so far generically, but preferably a deal evolves, as represented in FIG. 8, through stages—from deal creation 1002 (sometimes referred to as “deal initiation” or “deal proposal”), to deal acceptance 1004 (sometimes referred to as “deal inflection”, “inflection point” or “flash point”); to deal consummation 1006 (sometimes referred to as “purchase” or “flash purchase”). The deal develops between creation 1002 and acceptance 1004 by buyers join the deal and sellers bid on the deal; and transitions from acceptance 1004 to consummation 1006 as soft-committed buyers, if any, either leave the deal or join the deal.

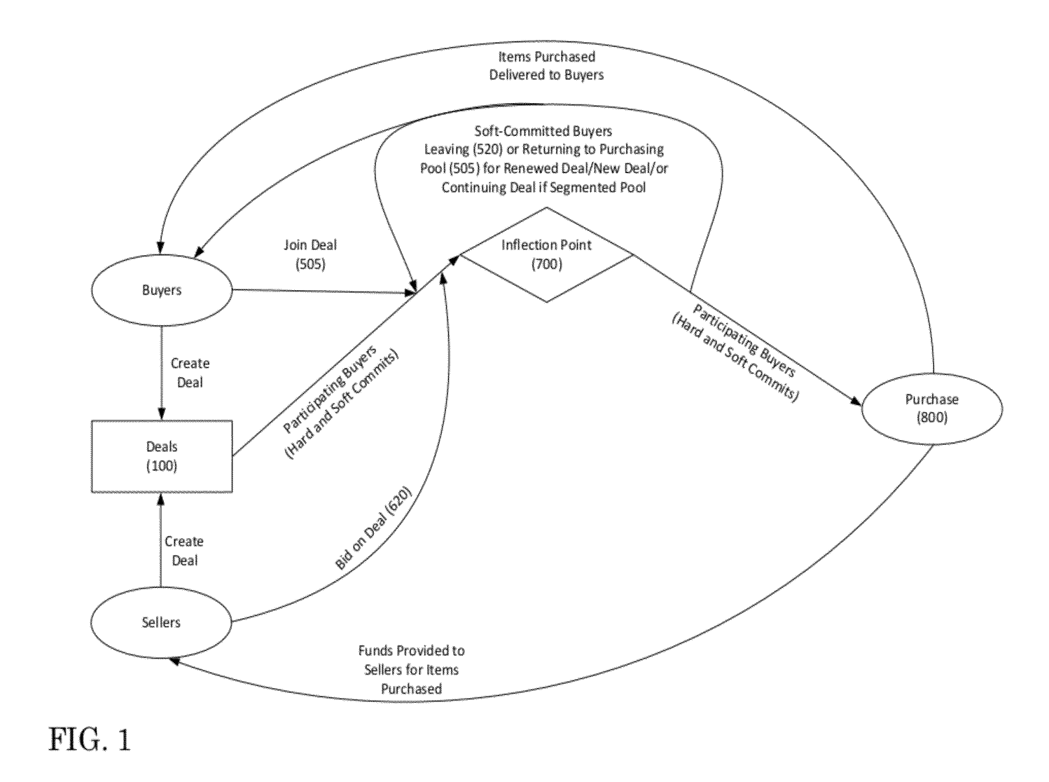

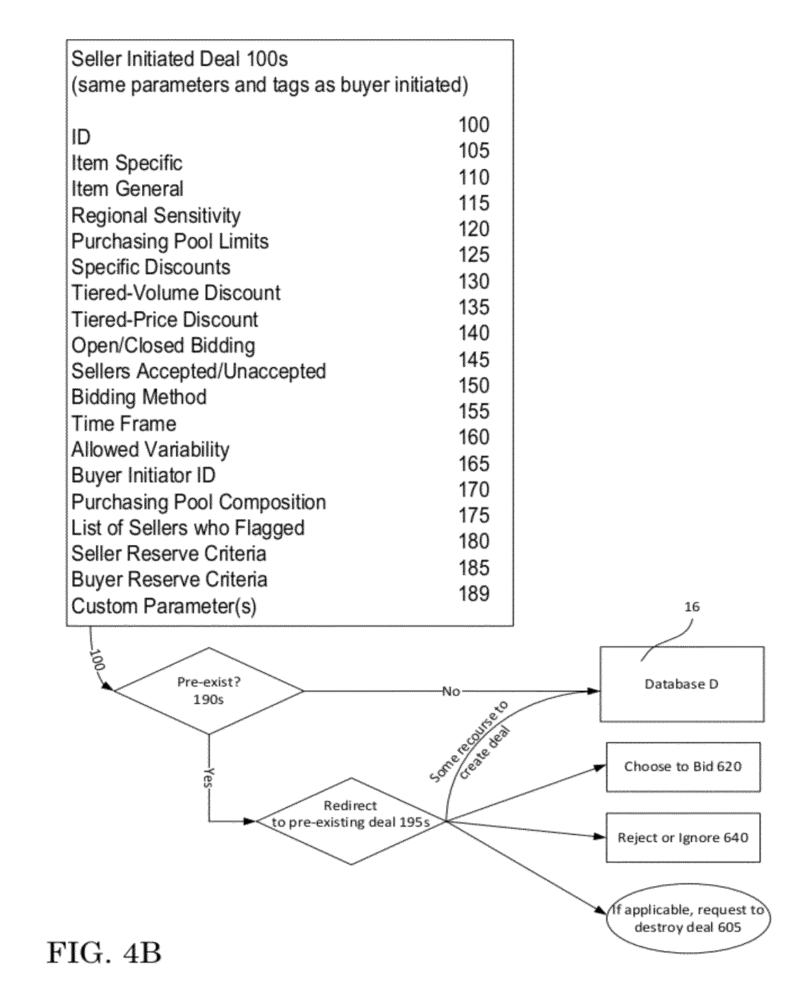

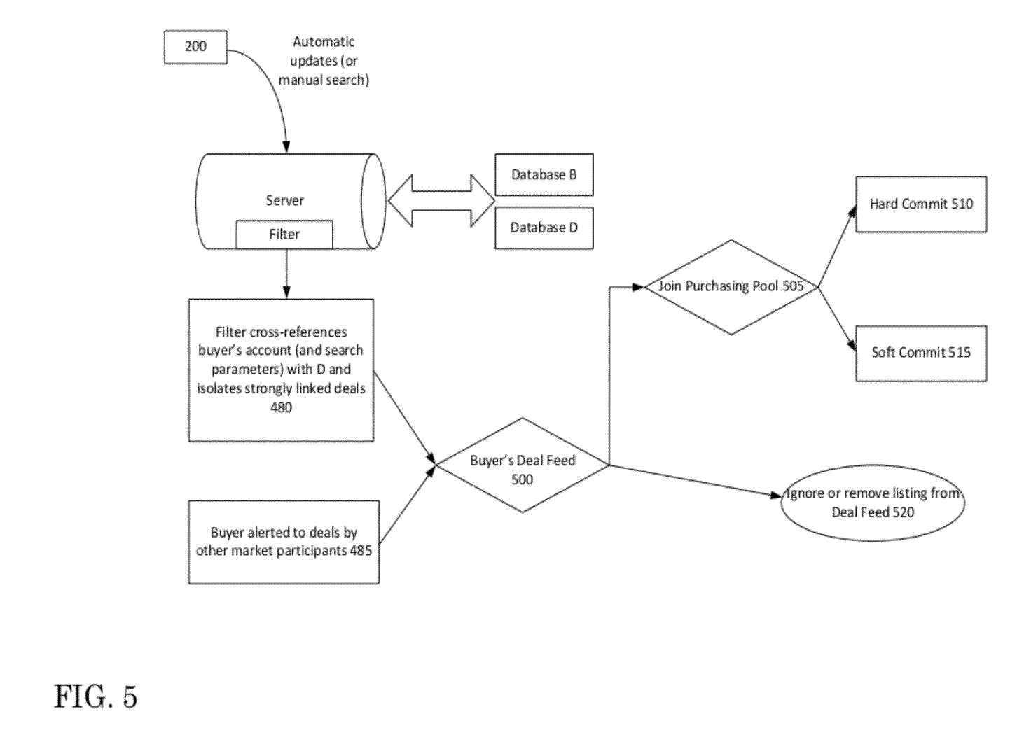

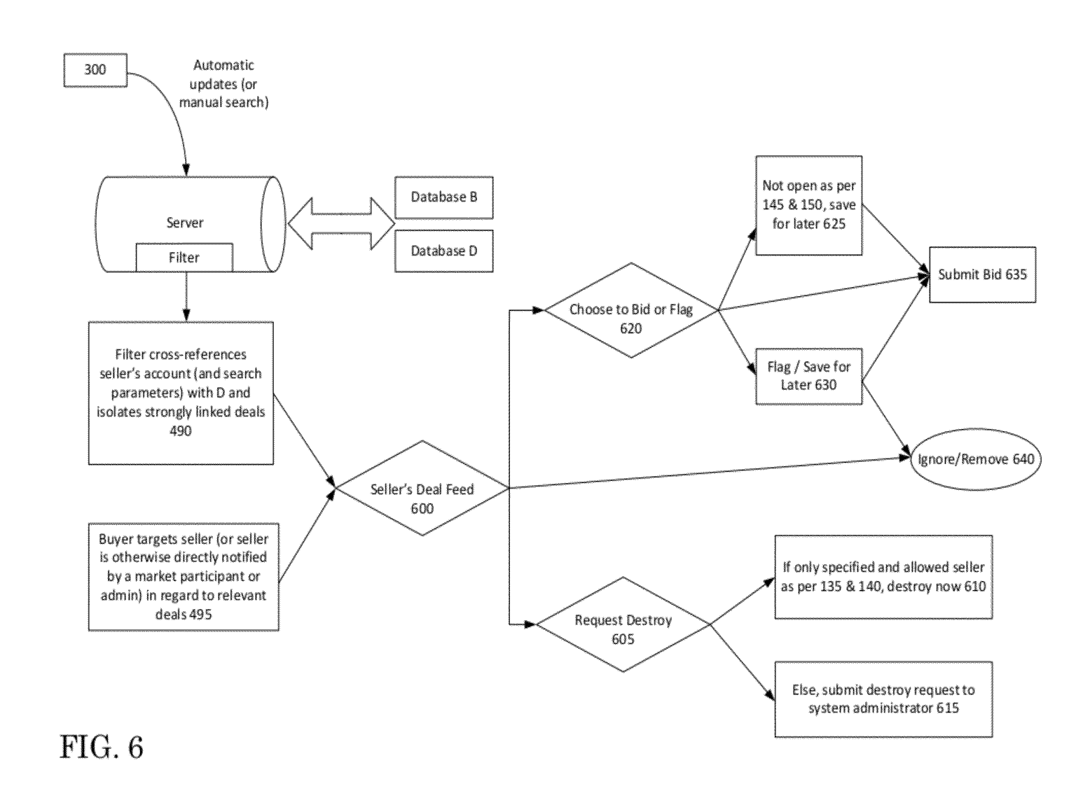

With now reference to FIG. 1, a deal event 100 is initiated, grows in buyer-volume until it is said to reach an inflection point event 700 (the point at which an acceptable seller has outbid its competitors or otherwise pledged to the deal), and becomes a purchase event 800 when the transaction contract is finalized and the purchase can actually take place with the agreed upon price cut. Preferably, only buyers join a deal (step 505 in FIGS. 1 and 5), and only sellers bid on a deal (step 620 in FIGS. 1 and 6). Each deal has a unique identifier and includes essential specifications as designed by whoever creates and negotiates the deal. Deal tags and parameters are registered into a deal database 16, as illustrated in FIG. 4, though some can be left open-ended.

Exemplary data fields of such a database 16 may include: a deal ID (unique identifying key in database); information related to a specific item; general item category information (if a specific item is chosen, then tag categories related to that item are attached automatically, otherwise tags can be chosen or entered manually); regional sensitivity information (for example, this might be related to limited shipping possibilities or other limitations due to item, buyer, or seller location; purchasing pool upper or lower participation limit information; information related to a specific discount set for a particular item; information related to scaling or tiering of a discount (when purchasing pool participation volume is open-ended, a discount may be tiered or scaled in relation to buyer volume), notably, in at least some implementations this may be encompassed by another related field; information related to a degree to which a discount may be tiered or scaled (when the item is open-ended, the degree to which the discount may be tiered or scaled in relation to retail prices for a range of items within a category), notably, in at least some implementations this may be encompassed by another related field; information related to openness (for example, whether or not the deal is open to unsolicited bids, and the number of sellers allowed participate); a list of solicited sellers; information related to an auction format and method of bidding; information related to a time frame (for example, when sellers can bid on the purchasing pool); information related to the allowed variability for a selection of the other parameters (this might address the variability allowed as set by individual buyers for any open-ended parameter besides just pool volume and general item—for example, a reserve price may or may not be open-ended and may or may not be variable for different buyers, and sellers may also track a deal and reach terms for an inflection point according to their own reserve criteria, granted that they are allowed to do this—custom parameters have an inherent variability), in at least some implementations, this may subsume one or more other described exemplary fields; a creator ID (which can be used to examine the rating of the buyer or seller); purchasing pool composition and membership information (which can facilitate sellers' decision-making)-information access may be tiered for different subscription levels (this parameter, or another, may also house the benefits for different subscription levels, as well as any other incentives discussed herein); a list of sellers who flagged the deal; information related to seller reserve criteria, as granted by information related to allowed variability (described hereinabove) and set individually by the participating seller in regard to a particular deal or set of deals; and information related to buyer reserve criteria, as granted by information related to allowed variability (described hereinabove) and set individually by the participating buyer in regard to a particular deal or set of deals.

Additionally, a deal designer may create one or more custom parameters. Custom parameters may include something unaccounted for in the other deal parameters, and require more reserve criteria from the buyer. Custom parameters may also allow for specialized segmentation of purchasing pools, as described herein below. This information might be captured, for example, in the parameters illustrated in FIGS. 4A and 4B.

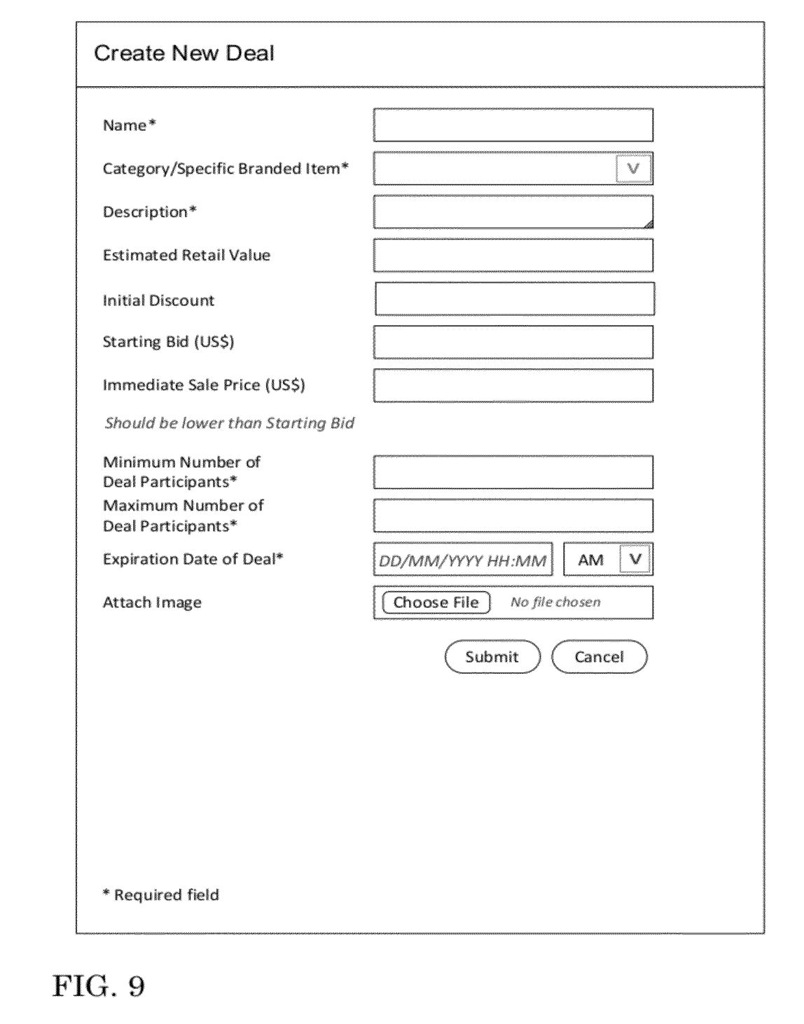

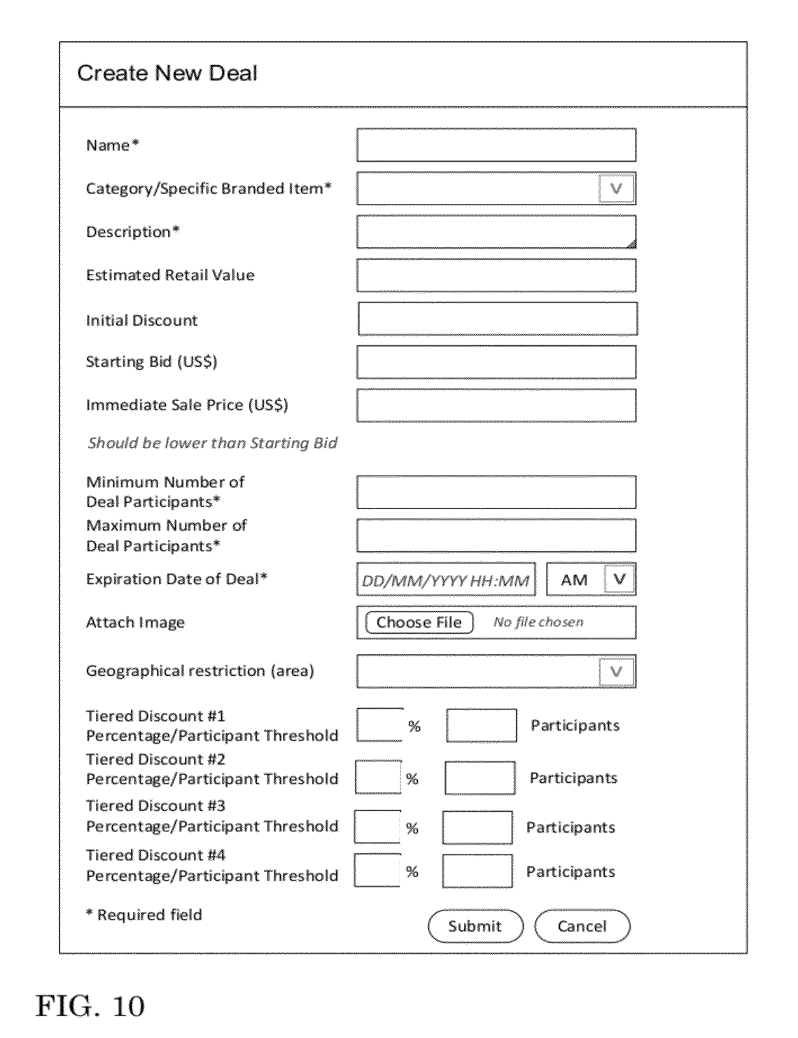

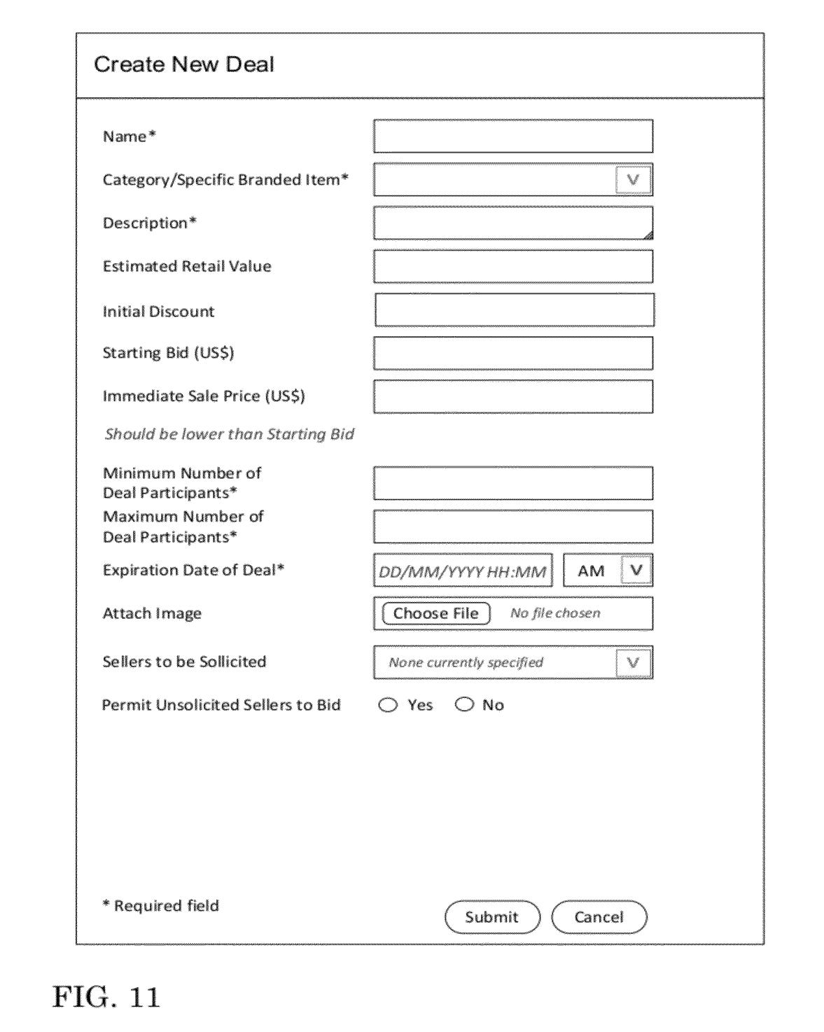

Some exemplary graphical user interfaces for creating or initiating a new deal are illustrated in FIGS. 9-11.

When a deal is gaining buyer-volume, some of these specifications are really targets. Preferably, before the inflection point, the target specifications can exist as a range of acceptable possibilities, such as general product categories, discount boundaries, and participation upper/lower limits. Then, once negotiating buyer(s) and seller(s) commit to a deal at an inflection point, these specifications become fixed.

In one or more preferred implementations, an exemplary system includes a feed component that lists deals, as illustrated in FIGS. 5 and 6. Preferably, the deal list plays multiple roles in the system at different steps in the deal-making process. The deal list is a live-streaming display of deal information that is tailored to individual market participants. The deal data exists on a central deal database 16, and certain deals are selectively streamed (or “filtered” at steps 480,490 in FIGS. 5 and 6) according to relevant parameters, meaning that a user's registered information, account settings, streaming preferences, and transactional history will determine the type of deals that populate their deal list. Since each deal is uniquely identified, selecting a deal from the deal list will link to its official registry page, or a user can act on the deal list itself as suggested in the figures. All parties can examine the deal list, but the deal list is preferably customized for different users with different intents in different environments. A user can customize these parameters by updating their account information, or a user can simply allow the program to monitor their various activities and algorithmically update the parameters.

In at least some preferred implementations, the deal list is a badge (made with JavaScript or RSS, for instance) that can be applied to a webpage and incorporated into other data streams. Buyers can interact with the deal list by joining a deal at step 505 or removing a deal listing. (Preferably, when removing a deal listing, a user has the option to request that their deal list exclude similar deals in the future.) A buyer might choose to put the deal list badge on their personal web pages and have it stream deals that they have initiated or joined. A seller may apply the badge to their company website. Such a badge acts as an advertisement, and would stream deals that are related to the company's products or services. If a buyer navigates the website and their browsing activity indicates interest in a certain item, the deal list will alert them of any relevant savings possibilities.

The deal list, of course, is just one component of a larger market system. Preferably, such a system enables many types of interactions between buyers and sellers, and between buyers or sellers and third party intervention, mediation, and informational services. These interactions can be categorized as: Buyer to Buyer(s); Buyer to Seller(s); Seller to Buyer(s); Seller to Seller(s); and Third party with Buyer(s) or Seller(s).

Exemplary systems preferably include mechanisms and features that facilitate these interactions. A description of how a deal evolves in relation to such market interactions will now be described with reference to the drawings. General steps for, and concepts related to, such evolution, and in-depth details related to these steps and concepts, will now be outlined. Some, but certainly not all, of these details are deal list related; in at least some preferred implementations, every interaction is enabled in part by a deal list that is tailored for particular users. Preferably, this tailoring is both user-set and automatic.

### Buyer-Initiated Deals

The first of these general steps involves buyers proposing deals for products or services, as illustrated, for example, in FIG. 1. FIG. 4A also relates to such a buyer proposed deal.

When proposing a deal, a buyer specifies a degree of discount, and the product or service can be of a general category or from a specific brand or seller. At the more specific end, the deal can identify precise model numbers or services isolated by location.

In preferred implementations, buyers can access an item (good or service) catalogue on a system webpage that calculates a pricing index and predicts tiered-volume discounts. These calculations are preferably generated, in part or wholly, from a registry of past deals. This registry may be open to perusal. Buyers can also search and browse current deals (that are still accumulating buyers) as well as expired deals (that are no longer accepting new buyers). Buyers are alerted if they are at risk of creating a redundant deal, meaning a deal that is similar to what they propose that is already gaining membership, and are encouraged to join the preexisting deal if that deal encompasses their purchasing needs. The catalogue also serves as a standardized product/service registry, so that a unique item will not be recorded multiple times in a redundant manner. Uniqueness is determined by the deal parameters and specifications, such as, for example: a model number; regional sensitivity; a minimum (or maximum) purchasing pool size requirement; product tags (used for categorization and deal list streaming); allowed variability in individual purchasing contracts (if a deal parameter is left open-ended, then the initiator may allow participating buyers to set their own additional conditions and boundaries for this parameter); and any other specification (for instance, a deal might be for exactly the same items or exactly the same categories but with very different discount requirements).

A deal may be for a single item or for a package of multiple items. For instance, a deal could be for items that would be provided by a single seller, such as a deal for multiple books or other media items all with similar subject matter. A deal could also be for items that would be provided by different sellers—such as dinner and a movie—in which case multiple sellers would all have to accept their individual terms in order for all and any part of the deal to reach an inflection point. Sellers can tailor their deal list to pick up deals for complementary items, and they could make a deal that is tagged as complementary to other deals and would thus have precedence in the deal lists of buyers in the complementing purchasing pool.

In a preferred implementation, a buyer, when initiating a deal, can create a price for immediate sale. Rather than bidding normally, a seller could then effect a pre-emptive bid by selecting a “Sell Right Now” option and selling an item at the price for immediate sale set by the buyer.

### Seller-Initiated Deals

Preferably, sellers can also propose deals. FIG. 4B relates to such a seller proposed deal.

The methodology of a seller-initiated deal is very similar to the above-described buyer-initiated methodology. In some implementations, a seller-initiated deal, however, may diverge in the way a deal reaches its inflection point and not invite bidding from other competing sellers. However, in at least some preferred implementations, seller-initiated deals are not so different from their buyer-initiated analogues: a competing seller may intervene and accept a deal at a lower buyer volume at either the same discount or an even steeper discount. A seller—and a buyer, for that matter—could initiate a deal for multiple items at a discount, thereby inviting more overall purchases. A seller is also able to initiate a deal for multiple items from different sellers and design the deal such that other sellers would have to participate in order for it to reach an inflection point.

In one or more preferred implementations, a seller is able to create a tiered pricing deal for which a seller can offer multiple, distinct price breaks that vary depending on the total number of deal participants (e.g., buyers). Preferably, a seller is able to set up a deal such that a particular discount applies to each of a plurality of bands associated with a particular volume of participants (for example, a 10% discount might be offered for 10-20 participants, while a 15% discount might be offered for 21-40 participants, and a 20% discount might be offered for more than 40 participants).

In theory, a seller or buyer could initiate a deal in which they do not participate. More generally, one could imagine a market flooded with deals to the extent that it is hard for any of them to reach an inflection point. In some preferred implementations, in order to prevent this, both sellers and buyers are given a maximum quota to the number of deals they can initiate per unit of time. In some preferred implementations, buyers and sellers with good records for initiating successful deals will be rewarded with higher maximum quotas, while those with poor records may be given lower quotas. There may also be a way for sellers and buyers to rate their approval/disapproval of any deal initiator. This rating would be recorded on the seller or buyer's account, and their average rating may affect the degree to which deals they initiate are prioritized on other users' deal lists. This rating could be a factor when a buyer or seller is either searching for a deal or being alerted to a deal.

In some preferred implementations, the only difference between buyer-initiated and seller-initiated deals is in how the system handles redundancy. If a seller tries to create a deal that already exists with their exact specifications or with significant redundancies, they will be redirected to any preexisting deals via their deal list or some other portal or registry, and given the opportunity to bid on those purchasing pools (bidding, such as at step 620 in FIG. 6, and alternatives, such as at steps 605 and 640, are discussed hereinbelow). If the preexisting deal does not meet the seller's requirements, there is recourse to the system administrators and they might continue to make a new deal pending administrative approval.

Sellers (and in at least some implementations only those sellers with a higher subscription level) can also access a de-identified version of the buyer database from which to make marketing decisions. There is also a warning system (preferably available to both buyers and sellers) that tells the deal creator if they are at risk of forming a deal that is unlikely to culminate in actual purchases. The system generates these warnings by examining the deal in relation to past deals that have identical or near-identical tags and parameters. If those past deals were unsuccessful, then the deal initiator is given a quick warning and a recommendation to change some deal specification(s), such as degree of discount.

### Deal Advertising

Preferably, deals are advertised or otherwise promoted. This advertising works in a number of ways. For instance, buyers and sellers, beginning with the deal initiator, advertise deals through their online network to accumulate collective purchasing power. A buyer's past actions and preferences affect their deal list stream, thereby alerting them to deals of interest. The deal initiator can also have the third-party manager publicize the deal through automated or other means via the deal list to other websites and individuals.

Preferably, the platform allows a participating buyer to broadcast deal information through various forms of online communication (such as, for example, email, social media posting, or to other people's deal list) in order to gain more participants in the purchasing pool. The platform preferably allows, for example through registration and user-profile customization protocols, a buyer to integrate their “buyer identity” with their various online communication tools. Under certain settings, disclosures, and licenses, a buyer's actions on the platform will preferably be automatically registered on their selection of communication tools and social media identifiers. With a series of simple operations (such as, for example, button clicks) buyers can more actively propagate deal information to their various online cohorts via automated messages or other form of directed alert. These advertisements can be generic and pervasive (i.e. the “shotgun” approach that targets their entire online network), or buyers can design customized advertisement arrays, wherein buyers selectively target particular cohorts or individuals and personalize their advertisements.

The deal list will also periodically and selectively stream current deals in a manner that takes into account user registration information and preferences (such as, for example, using filtering such as the filter step 480 illustrated in FIG. 5). Keyword tags, that the buyer attaches to their identity both actively and passively, determine the selective streaming. Demonstrated interest in a deal category is measured when a buyer joins or removes a deal on their deal list, and by letting the user prioritize keyword tags for particular items. The type of past deal commitment also factors in such that certain categories of goods or services are prioritized. Certain deal initiators (such as, for example, people in their network and particular people of interest) can be prioritized in the information stream. Aside from this periodic, selective streaming, buyers can also search the deal database for specific parameters and tags. This search portal is part of the deal list, but the portal may also be accessible elsewhere.

The deal list preferably will also respond to environmental cues, both physical and virtual, that correspond with deals. In an online environment, these cues include tag words for items that are related to the current actions and past history of a buyer's browsing and searching. A related item would be the item itself or a complementary item as determined by tag word relationships or purchasing patterns of other buyers. In the presence of such a cue, the deal list would stream and alert the buyer to any deal for the related item. In a physical environment, these cues include regional proximity between buyers and sellers. If a local seller is offering a deal, then nearby buyers will be alerted to that deal via their deal list. Conversely, if a buyer has a deal in their registry that is open to unsolicited bids, then a seller in that buyer's geographic proximity will be alerted to a transactional opportunity via its deal list, and the seller may contact the buyer and make an offer to the buyer's deal list (or through some other communication to the buyer).

As an example, a seller could create a deal for “dinner for two, three courses, New American, 25% off”, with an exact purchasing pool size of 1, and a deal list subscriber that ambles by with a friend could pick up that deal. In the converse example, a buyer would create that deal, which would be broadcast out to the deal lists of nearby restaurants who could then respond with offers, in which case the buyer could choose among offers.

### Buyer Participation in a Deal

Preferably, there are only two ways that a buyer can join a deal, but there can be a complicated set of conditionals that allow a buyer to qualify their participation. Thus buyers can participate in deals in different ways and can set personal conditions to a deal in the case where a deal is open-ended (which can be represented, for example, in parameter 160 of FIG. 4A).

Buyers can join a deal with varying levels of commitment. In a preferred implementation, buyers can make a “hard” or “soft” commitment. A “hard” commit (FIG. 5 at 510) entails a contract (an assurance contract when the lower participation limit is a key factor), whereby a buyer licenses access to a cash or credit account (such as PayPal, online banking, regular credit checking card information, or other account they registered as a user (FIG. 2 at 230)). This contract stands unless the bounds of the deal are breached by the seller's terms at the inflection point. These bounds include price, and in the case of an unspecified product or seller, the upper bound on price may be variable in consideration of the differences in base pricing for prospective options from various sellers.

For instance, consider a deal for Item X in Category Y. In the case where Y is fixed but the specific X is open for bidding, a buyer may agree to purchase a relatively expensive X only if the discount scales disproportionally in the buyer's favor. A buyer can set a base price range, set upper limits for various likely options of X, or choose the rate at which the discount changes with base price. A “soft” commit is a demonstration of interest or support for a deal; a “soft” commit is non-binding, but will ensure that a buyer is updated on the status of the deal and allowed to negotiate to the extent possible in that deal. A soft commit can be refashioned into a hard commit (which in at least some implementations may be the same thing as a purchase), but a hard commit may only be freely reduced to a soft commit before the inflection point. If the inflection point matches the terms of a buyer's hard commit, then that hard commit must be honored; if the inflection point does not match the terms of a buyer's hard commit, then their status is automatically reduced to a soft commit It is also possible to design a deal without room for such complicating contingencies, in which the exact discount, item, and seller is set, and the inflection point is reached without any sort of negotiation. (In this simpler scenario, it may still be possible for a competing but essentially identical seller to offer a competing bid for the same item at a steeper discount, because the discount parameters, such as, for example, discount parameters in parameters 125,130,135, do not normally have a lower limit.)

In order to determine a reserve price (the upper limit price of an item including any discount) it is necessary to determine the base price. The system preferably finds this base price by combing the web for the lowest price listed for a particular item and listing that price in the system catalogue, if price listings for that particular item are readily available online. If prices are unavailable online, the seller is expected to list accurate prices and compete fairly in the market system, otherwise they risk poor ratings or other penalties.

A system user can access a repository of past deals, ongoing deals, and suggested deals via the system portal. This portal and repository is accessible from Internet-ready devices, preferably including mobile devices. If a buyer is in a physical or online environment that has corresponding elements to the specifications and tags of their deals or purchases, then that buyer will be alerted and reminded of those relevant deals. For instance, if a deal or purchase is tagged for a specific location, then a buyer who has joined that deal but not yet obtained the item will be alerted when their mobile device is in that location. This reminds buyers with hard commits that they are in the vicinity of items that they have already paid for, and encourages buyers with a soft commit to consider making the purchase. Even without such environmental cues, the system preferably will periodically alert and remind buyers about ongoing deals in their repository.

Soft-committed buyers can exit a deal at essentially any time. However, hard-committed buyers can leave a deal only up until it reaches its inflection point. This assumes that the inflection point terms match their specifications—otherwise, they can leave after the inflection point as well.

A deal creator, when they create a deal, is automatically registered as a soft commit but is immediately given the option to convert to a hard commit. It is believed that there will be an accumulation of buyers in the purchasing pool as a deal develops from creation to acceptance.

### Inflection Points

There are different types of deals, and there are different ways in which a deal can reach an inflection point. The way a deal reaches an inflection point depends on whether the purchasing pool is coherent or segmented.

In the simplest case, the deal is very precise in its deal parameters such that potential buyers do not customize their individual purchasing contract. The purchasing pool is coherent, meaning that all buyers agree to the same terms. In this case, the seller enters a contract with the purchasing pool in an agreement to sell a specified item at the requested discount. A seller can bid on the deal (step 635 in FIG. 6) at any time when the deal is open for bidding according to the conditions of the deal. In particular, the purchasing pool must be greater than or equal to the minimum participation requirement as set by the deal designer, meaning that a hypothetical purchasing pool could theoretically have as few as only one member. For instance, if a buyer starts a very specific deal for an exact item at 50% off with no minimum purchasing pool requirement, makes a hard commit, and then a seller matches those terms before anyone else joins the purchasing pool, then the inflection point is reached and the deal closes. If there is a coherent purchasing pool at the time of the inflection point, then the purchasing pool is closed to new buyers and the deal is no longer registered as a deal in the system. Someone else could now start a new deal—for that same item model at half-price—without any redundancy warnings or redirections.

More complex scenarios can exist as well, such as when an item is introduced in a deal as a general category, at a variable discount, with regional-sensitivity, or other open-ended parameters that allow segments to form within a purchasing pool. In this case, a prospective seller is able to analyze the conditions set by hard-commit buyers. For instance, a seller can determine how many purchases they would be able to obtain by offering different items at a variety of prices. The system preferably also analyzes user records in order to predict the amount of soft-commit attrition under different deal arrangements. A seller preferably can then make an offer that seems optimal, and capture the applicable segment of hard-commits as well as some soft-commits. When this happens, it may be the case that only part of the deal reaches an inflection point, because only part of the purchasing pool was captured. In this case, the inflection point segment would split off from the deal. In theory, a segmented deal could have a steady-state input of new buyers who proceed to customize their purchasing contract and an output of inflection points that only satisfy some of those contracts. In this way, a deal may never end but still result in transactions.

A segmented deal is basically a set of multiple coherent deals. The system or system administration can restructure a segmented deal into individual deals when applicable. For example, in preferred implementations, if segmented deals are usually messy, then the system may consolidate similar deals, or otherwise discourage or even disallow the formation of the type of deals that would become segmented. However, segmented deals might have positive attributes. They might have a bigger purchasing pool, and even if that pool is segmented, it might attract more buyers and sellers. Within that pool, the degree to which buyers can customize their purchasing conditions could create rich demand graphs that might be more discontinuous if physically separated into discrete deals. These demand graphs, with more subtle contours generated from a larger purchasing pool, could give sellers valuable information. It also increases competition, spurring sellers to act and capture parts of the purchasing pool before their competitors.

Segmentation may elucidate the common traits of a group of buyers in ways less obvious than just their price considerations. For instance, similar flight schedules may band buyers together into a logical segment, and sellers providing complementary travel services may be able to target these segments.

As another example, buyers may be banded together for relocation services based on similar changes in address. This type of segmentation may be specialized because it is not always described by the standard parameters shared by all deals. In order to identify such specialized segments, it may be necessary to employ custom parameters. The custom parameters require additional information from prospective buyers in deal situations where buyers are expected to have different demands, so there is an inherent variability in the custom parameters that is meant to identify purchasing pool segments. The buyer's demands for the custom parameters can be stored with the rest of their reserve criteria (for example, utilizing parameter 185 in FIG. 4A).

In the flight schedule example, the custom parameters may include departing and arriving airports, as well as departing and arriving times. In the relocation schedule example, the custom parameters may include the change in zip codes. Again, these segments could be captured in multiple coherent deals (such as multiple flight items for specific dates, rather than one general flight category item in which buyers must specify their dates in a custom parameter) but it may sometimes prove valuable to have larger, segmented purchasing pools.

As suggested so far in the deal model, a particular seller can accept the terms of a deal at any point. At this inflection point, the seller has exclusive access to the purchasing pool or a segment of that pool. A seller faces two conflicting incentives. On the one hand, a seller wants to get access to a purchasing pool before their competitors, so it is in their interests to convert a deal to inflection point earlier rather than later. On the other hand, it may be more economical to offer a discount to a larger purchasing pool, thus the conflicting incentive to wait and let the purchasing pool grow. These conflicting incentives are believed to foster competition that ultimately benefits buyers.

In some preferred implementations, there are other models of inflection point conversion besides first-come first-serve. A deal may specify a single seller and strictly not allow unsolicited bids, in which case the singled-out seller would not have to worry about competition. A deal may also be designed such that it invites sellers to bid on the purchasing pool in an auction during a designated period of time once the purchasing pool reaches a certain volume.

Auction bidding occurs as a static one-time bid or in a dynamic auction, depending on applicability. A static bid may be more applicable when the item specifics are open-ended, as the static bids may differentiate themselves by offering different items or different deal combinations. When static bids are identical except for price, the superior price wins the auction. When static bids are sufficiently different and meet different demands of a purchasing pool with open-ended deal specifications, they may capture different segments of the purchasing pool (segmented purchasing pools are discussed in more detail elsewhere herein). A single seller could make multiple static bids, although in at least some implementations the number of bids is sometimes limited in order to achieve consensus among buyers, prevent too much segmentation, and limit attrition. A dynamic reverse auction may be more applicable in the case where the item is specific and only degree of discount is open-ended. Yet static bids may also be applicable in this case if it is difficult for the sellers to coordinate in a dynamic auction. In the dynamic auction, the sellers compete with each other with lower bids until either a designated period of time has elapsed or seller participation ends. The ultimate discount must, of course, be at least as great as the discount specified in the deal parameters and must be in accordance with the reserve price, otherwise the hard-committed buyers would have no obligation to make a purchase.

In preferred implementations, there are also pathways for negotiation. Preferably, seller liaisons are able to contact deal buyer leadership, and vice versa, via the system. They can communicate either through a private messaging service in the system or by exchanging outside contact information. Buyer leadership is comprised of the deal initiator unless they have consented to give negotiating power to another representative. The system administrators are also available to help push a deal through to an inflection point.

When a specific seller is targeted for a deal, that seller is preferably notified via their deal list and other direct notification. A seller may make an unsolicited bid on a purchasing pool only when the deal is open to unsolicited bids: A relevant but untargeted seller would be notified of this type of opportunity via their deal list or other form of communication. The deal list preferably periodically picks up deals depending on relevant parameters connected to the seller's business and thereby alerts the seller of a potential business opportunity. A seller may also search the database for specific deal parameters and tags. This search portal is preferably part of, or accessible via, the deal list, but the portal may also be accessible elsewhere.

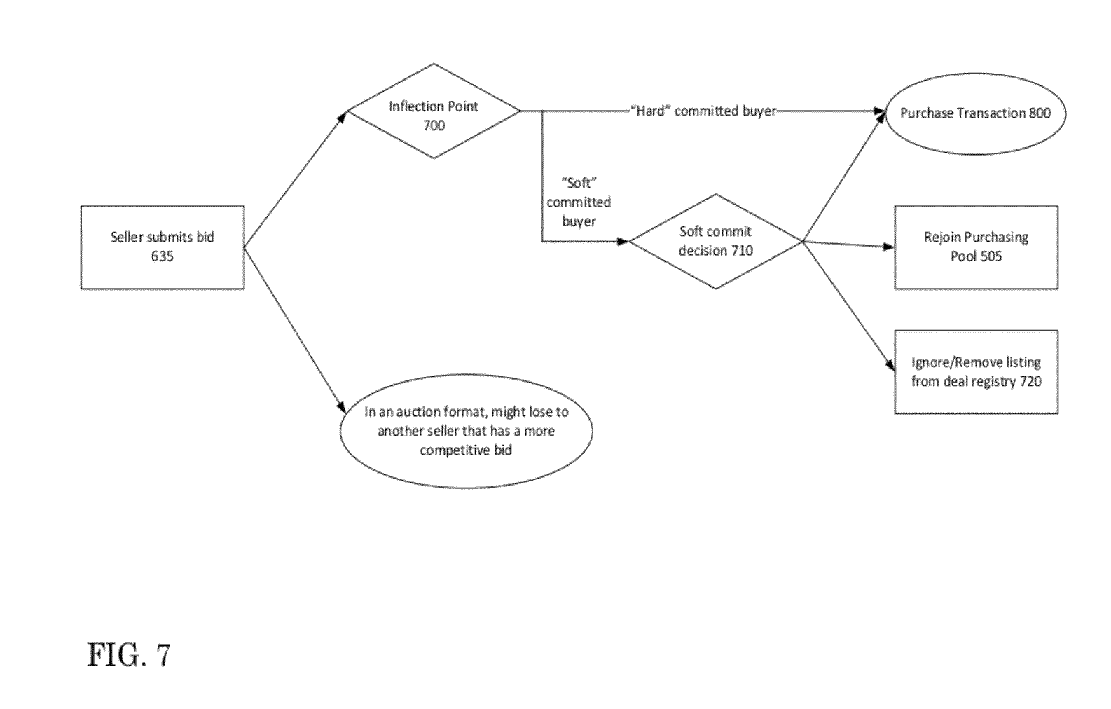

Once a deal is on their deal list, the seller goes through the mechanics of bidding on or rejecting the deal. With reference to FIGS. 6 and 7, if they choose to bid 620, then they must bid according to the auction format. In the standard first-come first-serve model, they can bid immediately 635, or flag the deal and save any action for later 630. When an auction is involved 625, the deal is flagged, the seller is updated on the status of the deal, and the seller is invited to bid when the auction opens. Once they bid (and if they win any necessary auction), then the deal reaches an inflection point 700.

A seller may choose to flag a deal 630 even if it has open bidding, thus protracting the transaction process. Once flagged, the deal may still be listed on the deal list or on a separate registry or other portal. The seller will be notified about any significant changes in the status of their flagged deals, such as changes in buyer volume past certain thresholds or inflection point conversions by other sellers. A seller may also set the reserve criteria parameters 180 for flagged deals such that when those reserve criteria are met, either an inflection point is reached automatically or the seller is notified and they may then place a bid to reach an inflection point. These flagging services may be available to sellers based on their subscription membership level.

When considering a deal, a seller can access attrition information breakdowns comprising the number of hard commits plus predicted soft commit yields. Hard attrition is determined by the boundaries set by individual buyers in their hard commit contract. Soft attrition predictions are generated from past user history. In the pool of soft commits, each buyer is analyzed for their overall yield rate and their yield rate for similar deals. This data comes from a de-identified version of the buyer database. If the seller has any past attrition breakdowns for deals that went through, that data is analyzed for predictive value. These services, and the ones described next, may also be available depending on the level of a seller's subscription membership.

When applicable, a seller can examine attrition breakdowns and yield predictions for different discounts and different items. A seller can examine ordered lists of individual hard commit contracts, such that they can isolate buyer segments with particular discount agreements for particular items. When applicable, a seller could reach an inflection point that captures only those segments by setting their reserve criteria parameters 180.

### Purchases

A deal is said to have become a purchase, i.e., been “consummated”, when a seller and buyer have committed to terms at and after an inflection point and are ready to commence transactions. Buyers with consenting hard-commit contracts will have the purchasing amount deducted from a pre-specified account, and they will be registered as entitled to the respective deal item and given a receipt (or anything else that provides evidence of purchase that must be honored by the participating seller) that they can present to the seller if necessary. The purchase will also be listed in the deal repository of each market participant. The payment from the buyer and the item provided from the seller culminate the purchase transaction. If they have not yet acquired the item, they will be reminded periodically of their purchase. If they have not yet acquired the item at the fault of the seller and request recourse, they can preferably submit a complaint to the system administrators who will resolve the complaint.

In preferred implementations, in the case when the deal item is shipped, the shipping is tracked so as to confirm that the item is automatically shipped to hard-committed buyers in the same way that the corresponding sum of money was automatically deducted from their accounts in payment to the respective seller. Once shipped, the deal is recorded in the buyers' and sellers' registries as past purchases.

If the terms of an inflection point do not match the specifications of a buyer's hard-commit, and that buyer was somehow in the captured purchasing pool segment, then that commitment is converted from a hard commitment to a soft commitment.

At an inflection point, buyers with soft commitments can choose whether or not to purchase. If they buy, then the transaction proceeds in the same way as described above for buyers with consenting hard commitments. If they turn down the inflection point offer, then they can choose to either re-enter the deal purchasing pool or abandon the deal. Re-entering the deal is the same procedure as if they were joining originally, with the new option to just repeat their previous joining conditions. In most cases, buyer volume will probably decrease from inflection point to purchase (the downward slope of the “Purchasing Buyers” arrow in FIG. 1 is meant to suggest attrition). This attrition may be somewhat predictable based on the number of hard commits, the terms of those hard commits, and the number of soft commits. The past behavior of buyers is also recorded and, as discussed earlier, preferably available to prospective sellers to help them predict attrition.

In one or more preferred implementations, all deals created by sellers, or won by sellers, are stored for later remarketing to buyers.

### Monetization Methodologies

Purchase events are one of the points at which an exemplary system can make money. In some preferred implementations, there is a commission on each purchase, such that a small part of the payment on each transaction is redirected to a system owner or other entity. In some preferred implementations, commissions or additional discounts may also be given to deal initiators and anyone responsible for advertising the deal in proportion to their success in getting their contacts to join the purchasing pool. Hard-committed buyers could also get an additional price cut by paying them back all or part of the commission on their purchase. If commissions are big enough, then this could be a significant incentive for choosing hard commits over soft. The commission negatively impacts the amount that the seller collects, and does not negatively impact the buyer's discount. When deals are being created, the system clarifies the size of the commission to the seller, so as to make transparent the expected deduction from each purchase. When a buyer is choosing between joining as a hard or soft commit or converting between these two levels, the system informs the buyer of any extra savings gained from choosing a hard commit.

Additionally or alternatively, an exemplary system can make money by selling purchasing pools to interested sellers. This presents a different model for how a deal reaches an inflection point, but may be applicable in certain cases, such as when a purchasing pool is very large. In this alternate model, a seller or competing sellers would enter an auction to buy one or more purchasing pools or one or more segments of purchasing pools. The system owners would get paid from the auction, and the winning sellers would get exclusive access to their newly acquired purchasing pools. They can make an offer such that any hard commits are converted to purchases, and the seller may pursue any soft commits and try to get them to make purchases.

There are additional ways the system may generate profits. It may require an entry-fee subscription from buyers or sellers in order to join certain purchasing pools or bid in certain auctions. Access to the system more generally may require a subscription service. Sellers may be rewarded based on a subscription member level with greater information or access, for example as discussed herein. Buyers may also be rewarded with greater discounts or entry to more exclusive deals based on a subscription level. There may also be sponsorship opportunities, whereby a sponsor subsidizes additional discounts for buyers in return for greater exposure, purchasing pool access, or other action from the buyer or from the system that rewards sponsorship.

### Loyalty System

In one or more preferred implementations, a loyalty point system is utilized that is tied to user ratings as well as earned by promotional action such as emailing or promulgating a deal through social networks. Alternatively, or additionally, points can also be earned by either offering a deal or participating in a deal, and points can be offered. For example, points could be earned for participating with specific sellers, which would create a seller loyalty program around deals; points could let users get greater discounts with those specific sellers, or greater discounts regardless of seller. A seller could use points earned by creating deals or receiving good ratings towards reducing the commission redirected to a system administrator. Points would possibly be recorded for individual buyers and sellers as part of their account information; points would be accumulated in finite amounts for performing certain actions discussed herein, and “spent” either in finite deductions for the benefits discussed above, or such benefits will be available when points have been accumulated past a certain threshold level.

### Exemplary Website

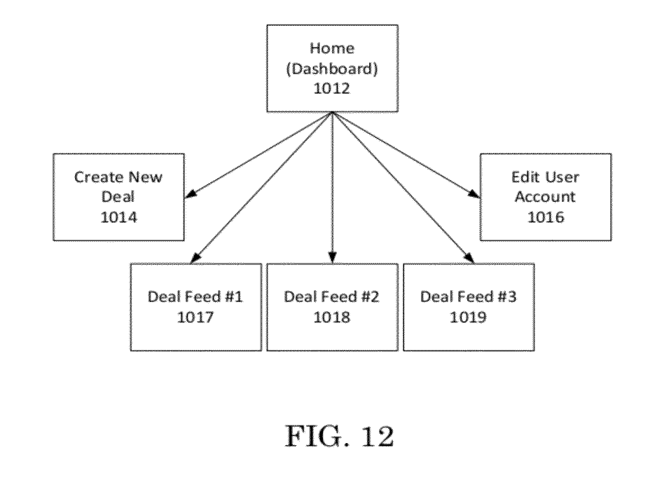

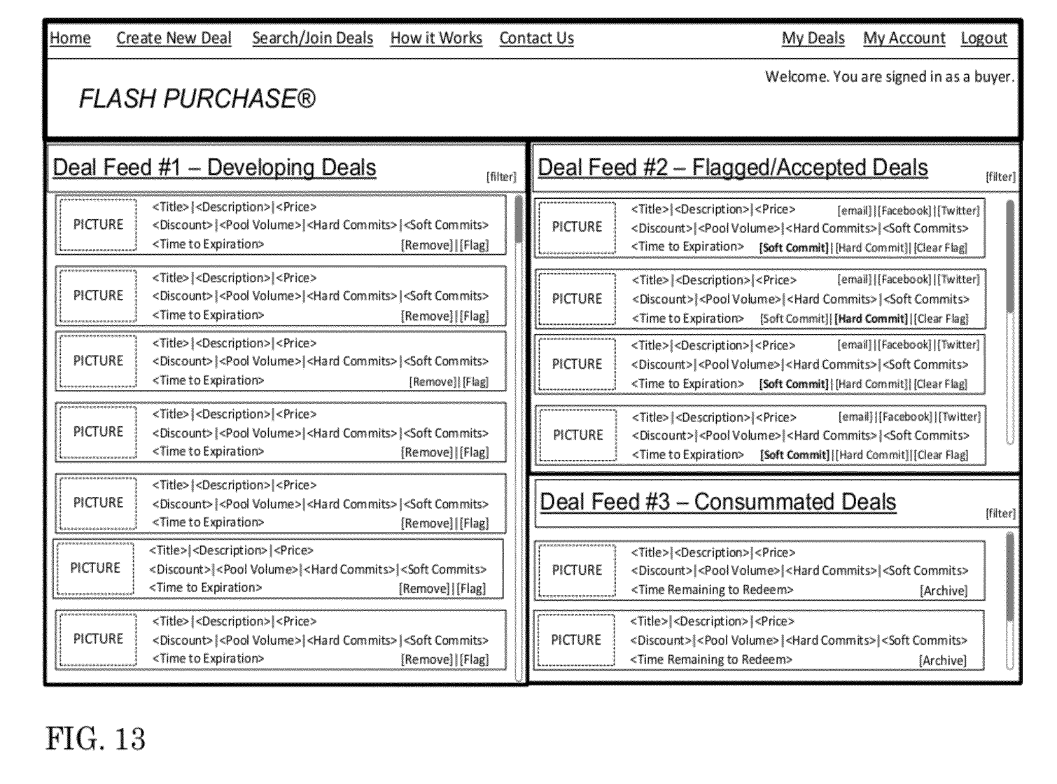

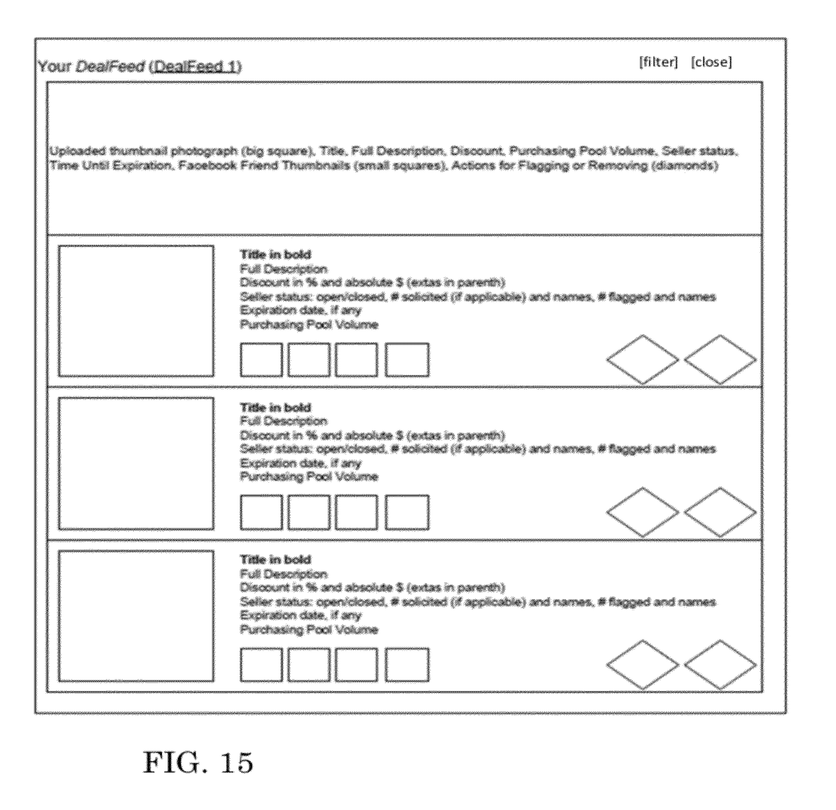

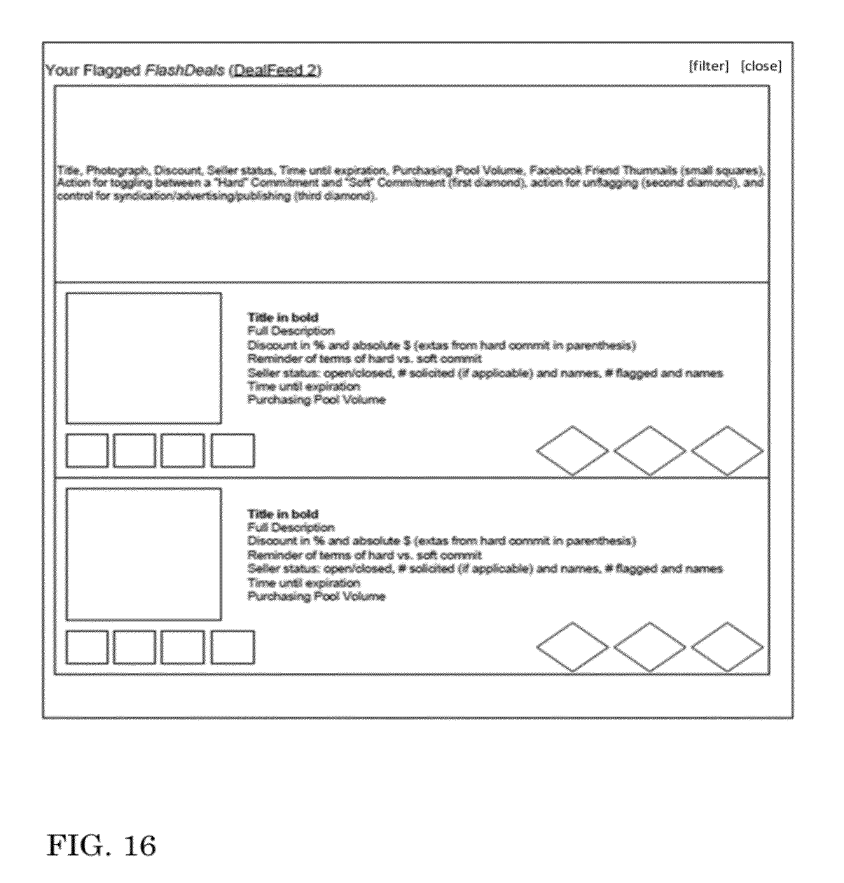

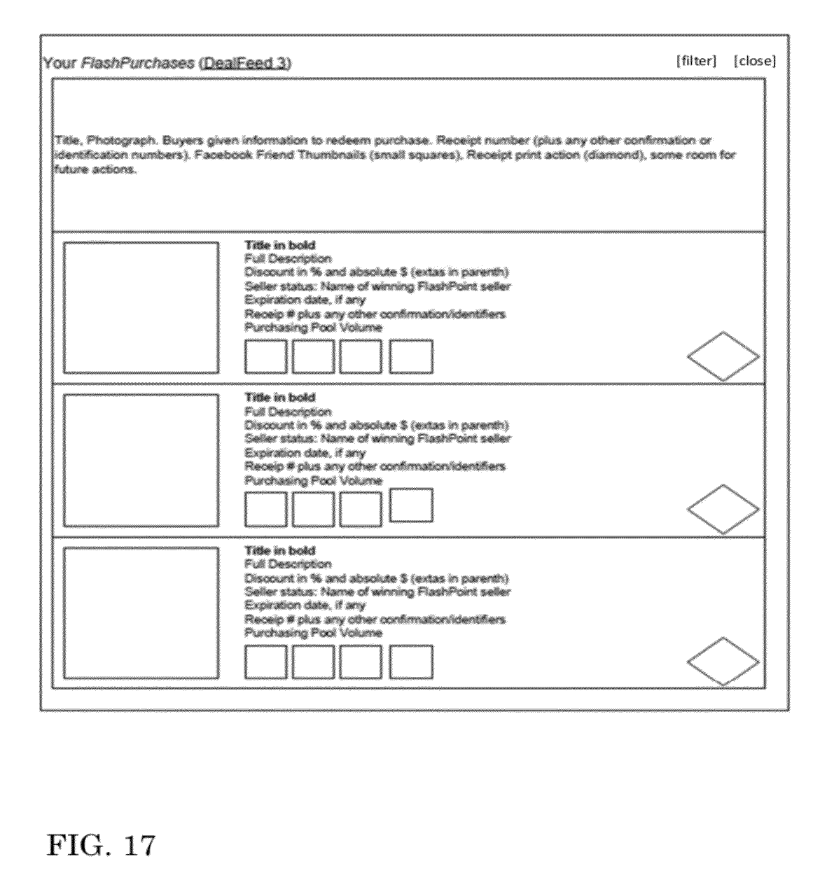

FIG. 12 is a schematic illustration of a basic website representative of one or more preferred systems in accordance with the present invention. The website includes a home page 1012 comprising a dashboard where a buyer or seller will primarily spend most of the time on the website. An exemplary dashboard for a buyer is shown in FIG. 13. Upon clicking on any of the deal feed titles in the dashboard, for example, a window is presented that sets forth the deals of the selected deal feed in greater detail. Such a window 1017 for Deal Feed #1 of FIG. 13 is schematically illustrated in FIG. 15; such a window 1018 for Deal Feed #2 of FIG. 13 is schematically illustrated in FIG. 16; and such a window 1019 for Deal Feed #3 of FIG. 13 is schematically illustrated in FIG. 17.

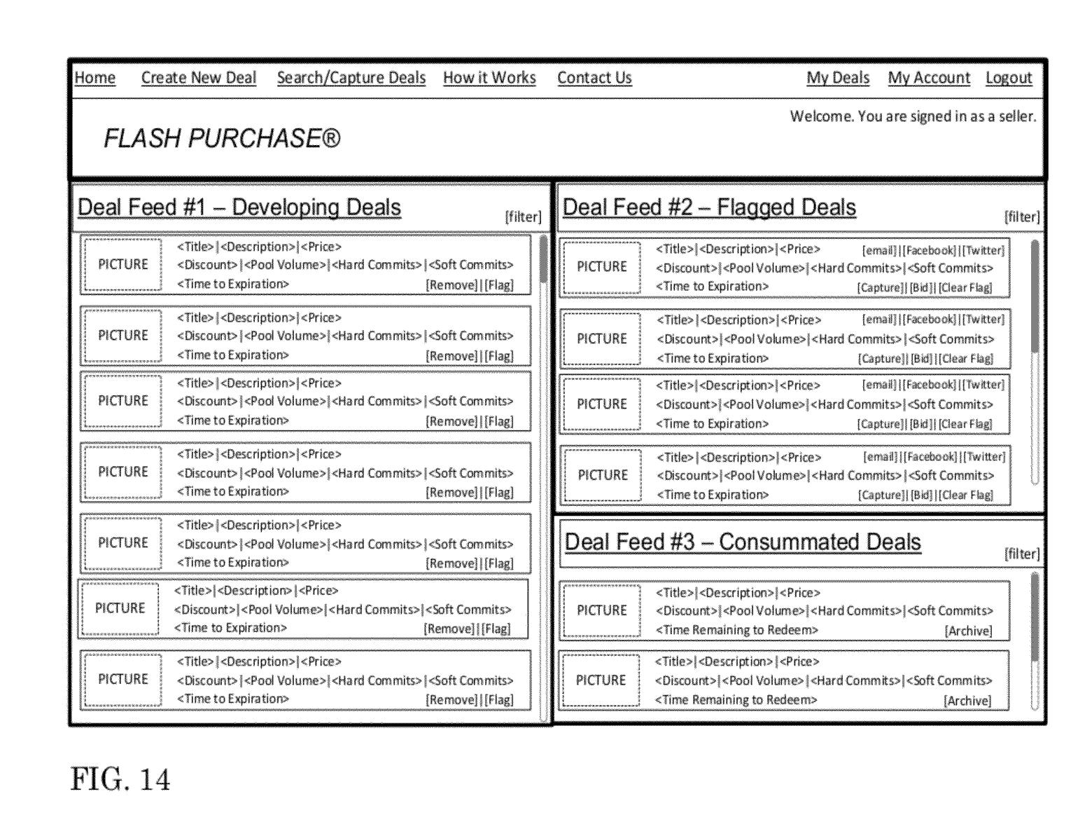

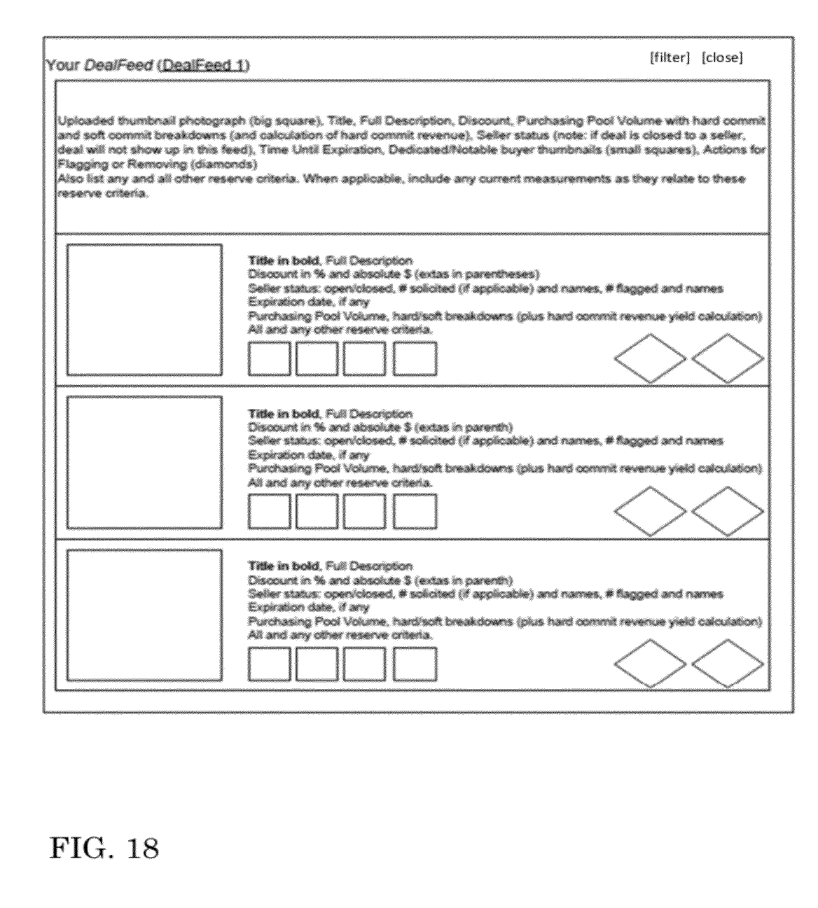

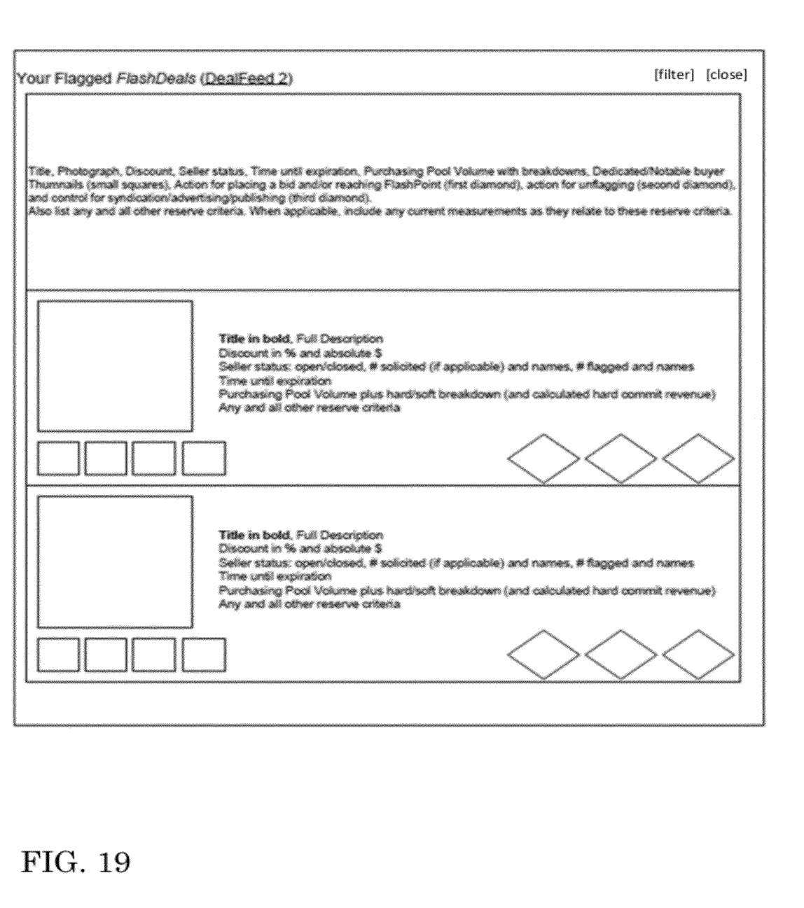

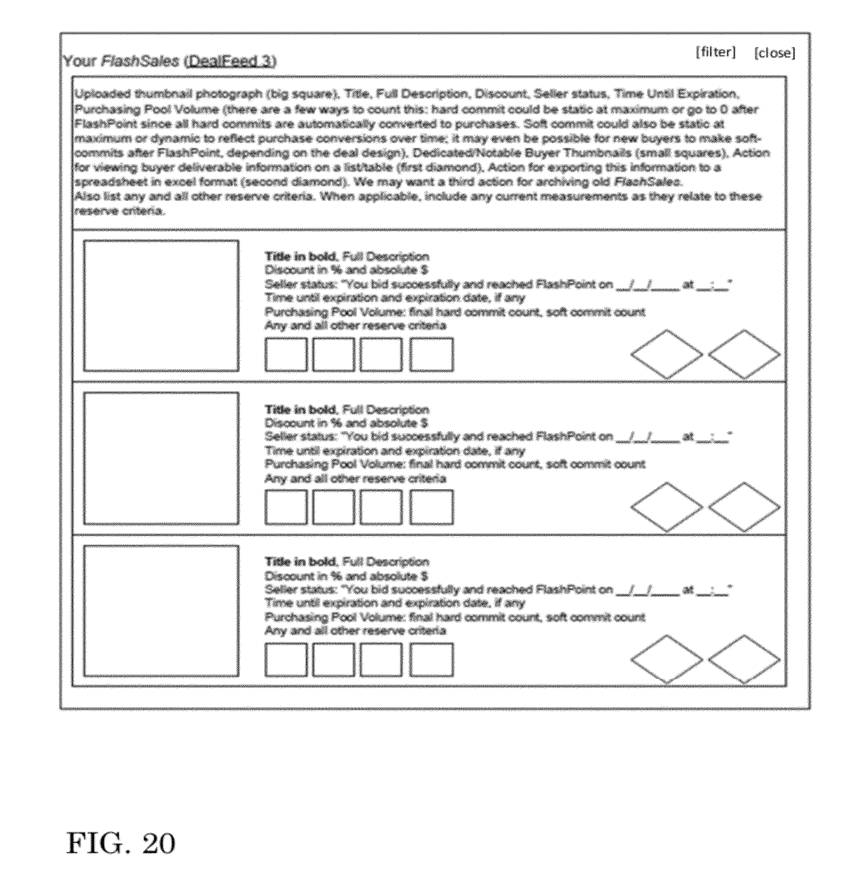

Similarly, an exemplary dashboard for a seller is shown in FIG. 14. Upon clicking on any of the deal feed titles in the dashboard, for example, a window is presented that sets forth the deals of the selected deal feed in greater detail. Such a window 1017 for Deal Feed #1 of FIG. 14 is schematically illustrated in FIG. 18; such a window 1018 for Deal Feed #1 of FIG. 14 is schematically illustrated in FIG. 19; and such a window 1019 for Deal Feed #1 of FIG. 14 is schematically illustrated in FIG. 20.

Referring back to FIG. 12, another web page 1014 enables the buyer or seller to create a new deal. The graphical user interface of that page 1014 may be similar to those shown in each of FIGS. 9, 10 and 11.

Another web page 1016 shown in FIG. 12 allows the buyer or seller to edit that user's account.

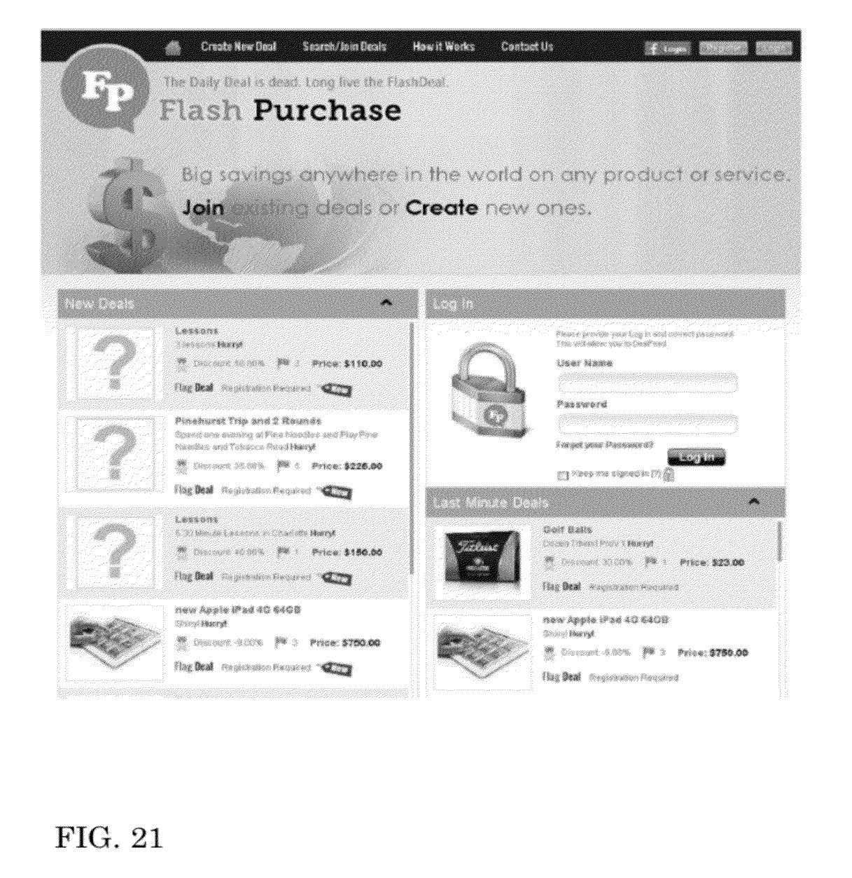

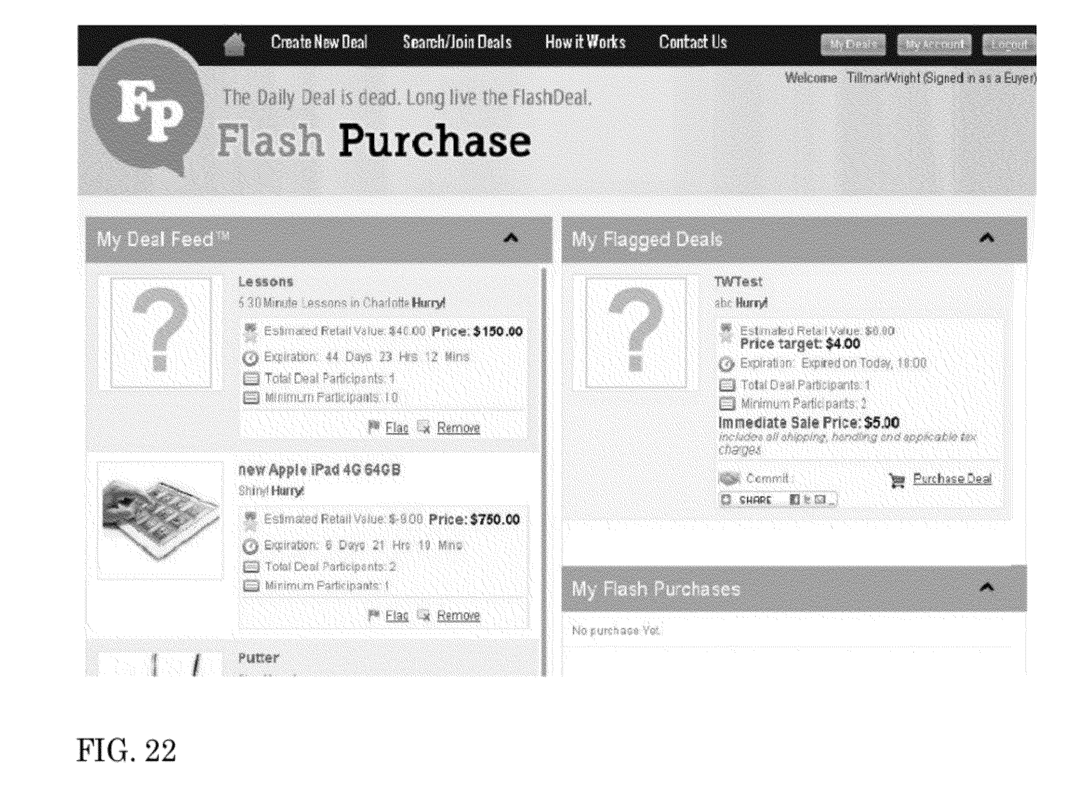

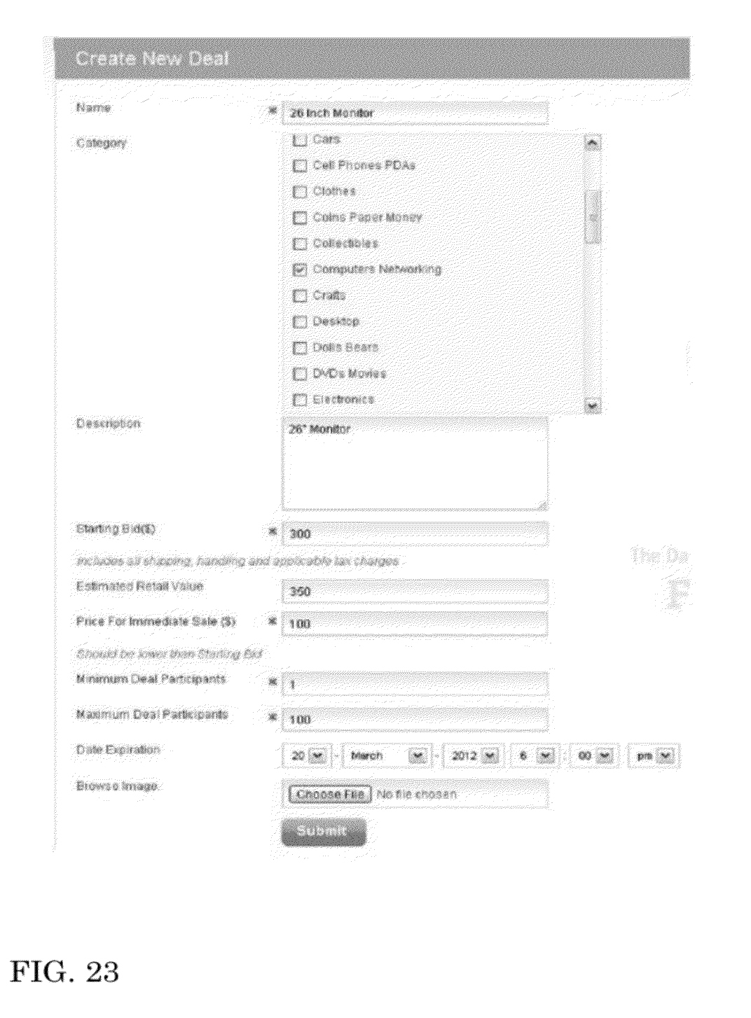

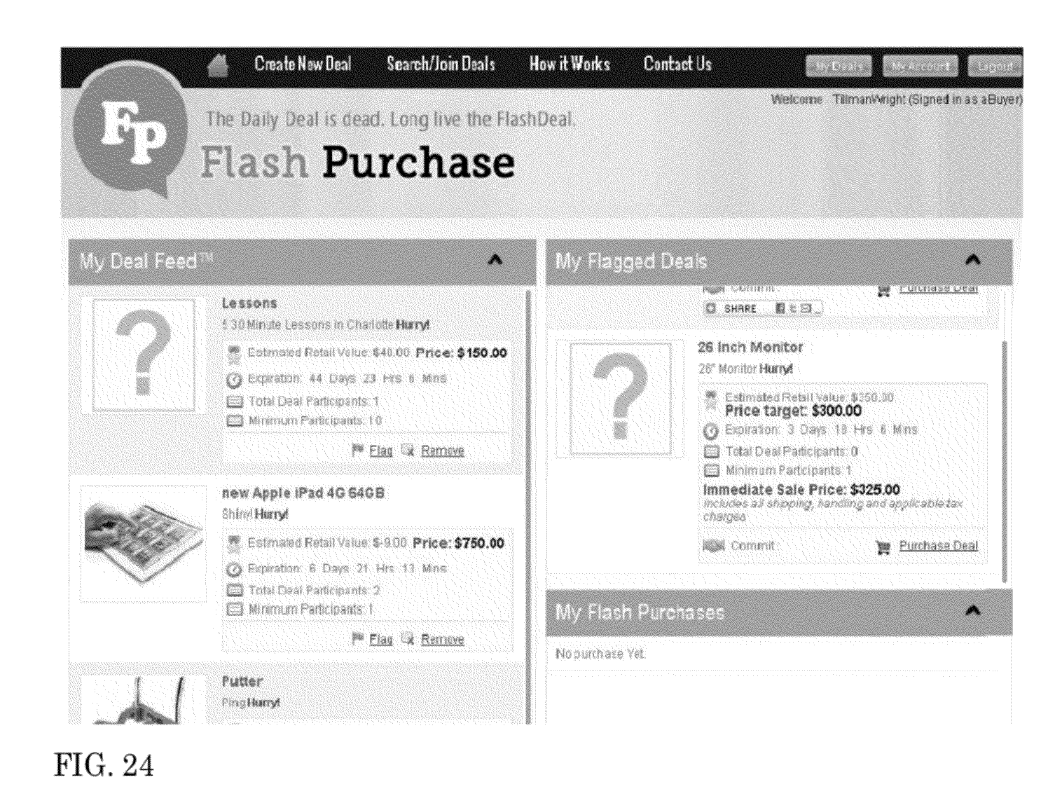

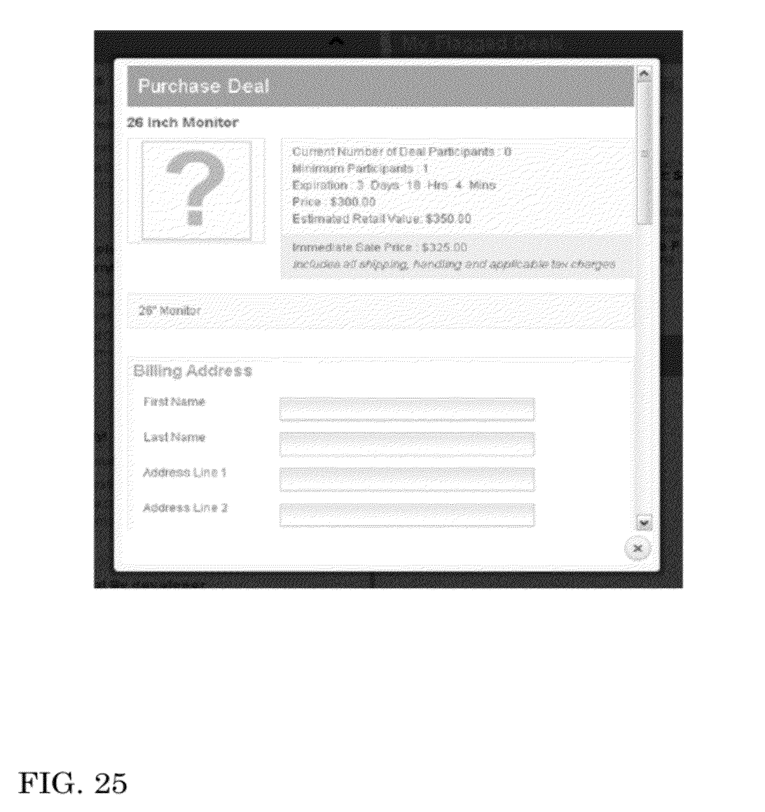

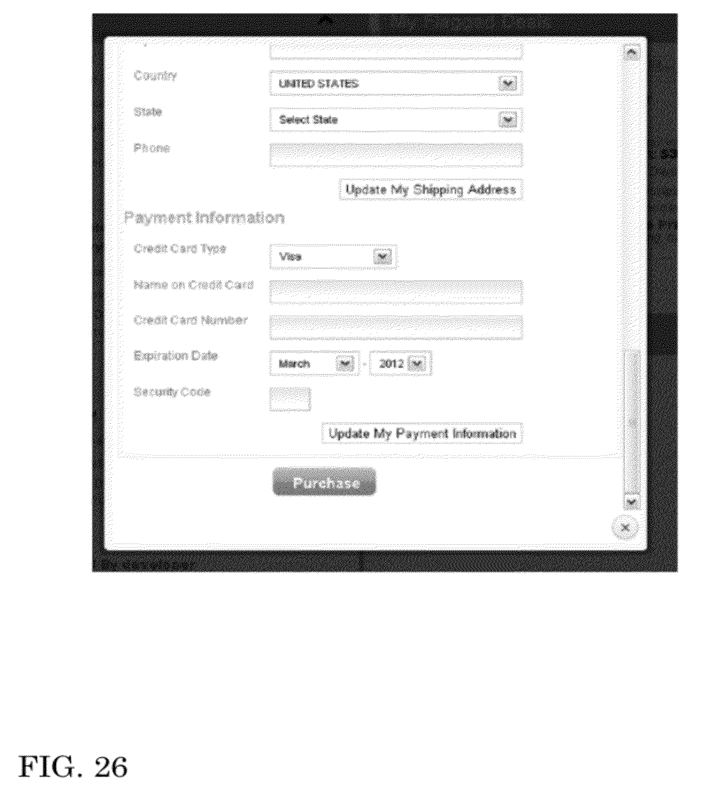

FIGS. 21-29 illustrate screenshots of a prototype website under development that is in accordance with an exemplary preferred implementation of the invention. The website allows users to register, and subsequently login, as a buyer or seller, as illustrated in FIG. 21. Upon logging in, a buyer is presented with a homepage showing their deal list, a list of deals they have flagged, and a list of their purchases, as illustrated in FIG. 22. A buyer can create a deal via a page of the website, as illustrated in FIG. 23 and, upon creating a deal, the deal will appear in that buyer's flagged deals list, as illustrated in FIG. 24. As can be seen in FIG. 22, a “Purchase Deal” link is presented for each deal in the buyer's flagged deal list. A buyer can choose to commit to purchasing a deal by clicking on this link and accessing a purchase interface, as illustrated in FIGS. 25-26.

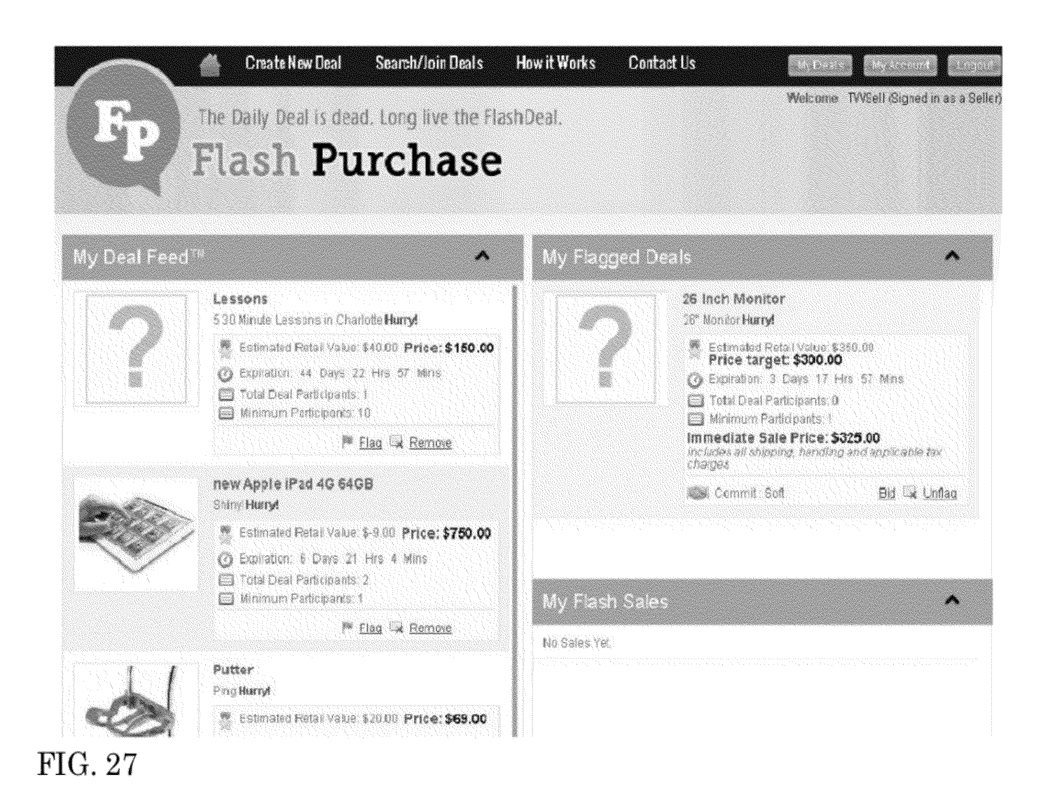

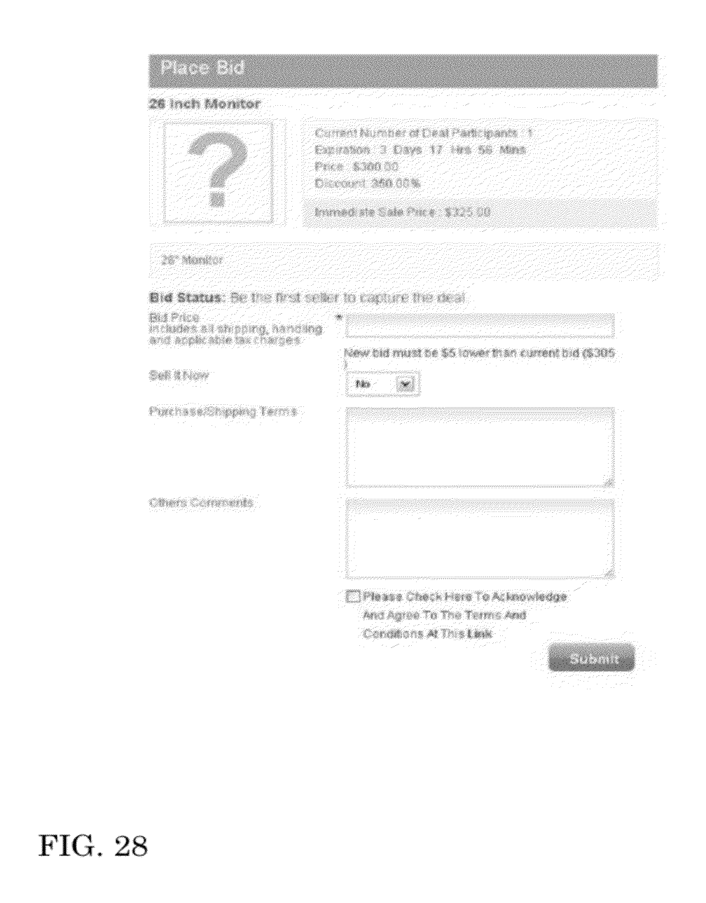

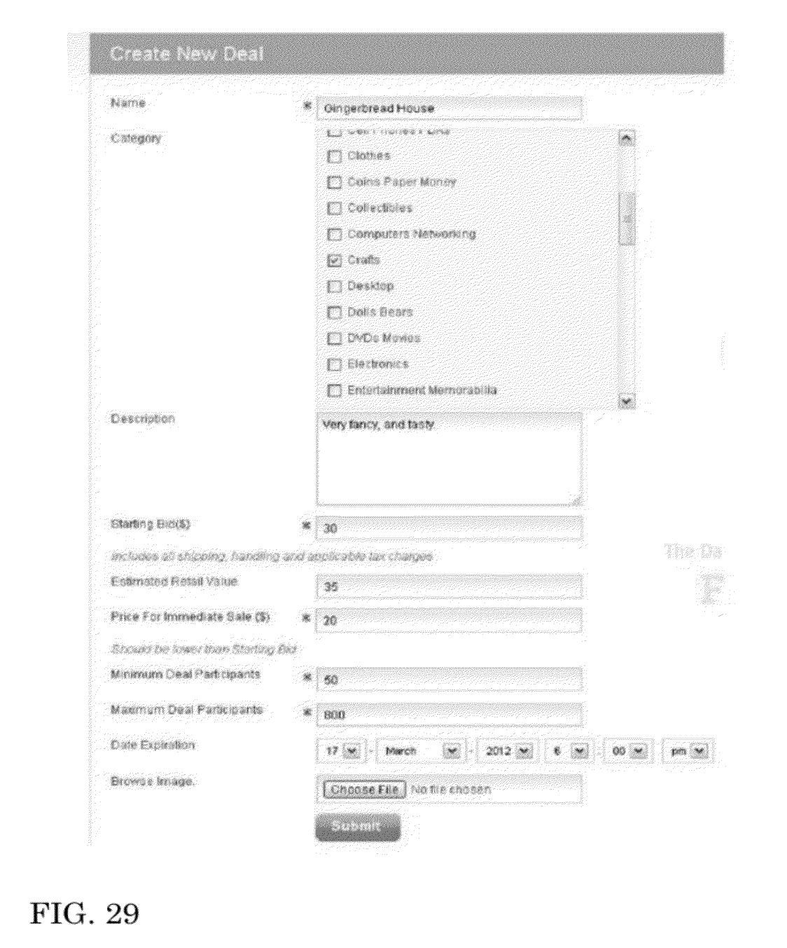

In similar manner, upon logging in, a seller is presented with a similar homepage showing their deal list, a list of deals they have flagged, and a list of their sales, as illustrated in FIG. 27. Whereas buyers are presented with “Purchase Deal” links for each deal in their flagged deals list, a seller is presented with a “Bid” link, as illustrated in FIG. 27. A seller can click this link to access a bid interface, as illustrated in FIG. 28. Like buyers, a seller can create new deals. FIG. 29 illustrates a create deal page for creation of a deal by a seller.

Preferably, the website is set up to provide alerts to users upon certain events. For example, upon editing of a deal, all buyers and sellers who are interested in the category of the deal item being edited are alerted, such as by email. Additionally, all buyers, including hard commits, soft commits, and those who are interested in the category of the deal item, preferably get an alert when items are won by a seller (or seller), and given a set period of time, such as 48 hours, to purchase. Further, losing sellers are preferably informed, and a winning bidder gets an alert (such as by email) and details of logistics.

In view of the foregoing, it is believed that setting the terms of negotiation may be necessary for certain proposed deals, and savvy buyers may appreciate the ability to outlay their terms and reach a compromise without all of the hassle of turn-wise, iterative bargaining. However, it is likely that less complicated proposed deals—advertised with exact items at exact discounts—will be more popular. In these less complicated scenarios, the seller still needs to consider the purchasing volume at which the discount becomes worthwhile. The buyer, however, does not need to invest as much thought.

In view of the foregoing, it is believed that if a seller has a monopoly over a purchasing pool, they could systematically time the deal acceptances in a way that follows the marginal increase in discounts. For instance, they could reach a deal acceptance first with hard-committed buyers who approved a 20% discount, then 25% discounts, then 30% discounts, up until it becomes unprofitable. In a more competitive environment, sellers would have to collude in order to take advantage of the hard-commit discount margins. Without monopolies and without collusion, buyers should ultimately benefit by getting better deals in shorter time, and the system may take measures to safeguard this buyer's benefit.

Additionally, in view of the foregoing, it is believed that a seller could create an “ongoing” deal that lets buyers join the purchasing pool after deal acceptance. In this case, a single ongoing deal would have multiple deal acceptances and multiple influxes of buyers, which may suit the seller better than creating a series of separate but identical deals

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1. A method of facilitating the exchange of goods and services between buyers and sellers in an electronic marketplace, comprising:
(a) providing an electronic marketplace which is accessible by users through Internet communications and through which,
(i) users propose deals,
(ii) users review proposed deals,
(iii) users comprising buyers join proposed deals, and
(iv) users comprising sellers accept proposed deals; and
(b) receiving and storing sufficient user information to effect a transfer of electronic funds from a financial account of one user to a financial account of another user for an accepted deal to which the users are parties;
(c) wherein the users comprising buyers join proposed deals by committing to the deals through the electronic marketplace.

2. The method of claim 1, wherein users comprising buyers propose deals which users comprising sellers accept.

3. The method of claim 2, wherein a proposed deal requires a specified minimum number of users comprising buyers who must join the proposed deal in order for the proposed deal to be accepted by a user comprising a seller.

4. The method of claim 1, wherein users comprising buyers are each able to specify, through the electronic marketplace, reserve criteria for a proposed deal which, if the respective reserve criteria of such a buyer is met, results in such buyer joining the proposed deal.

5. The method of claim 4, wherein users comprising sellers are able to view, through the electronic marketplace, reserve criteria of respective buyers for a proposed deal.

6. The method of claim 5, wherein users comprising sellers are able to bid, through the electronic marketplace, on a proposed deal.

7-8. (canceled)

9. The method of claim 1, wherein a committed buyer is able to leave a proposed deal to which the committed buyer has joined prior to acceptance by a seller by withdrawing the commitment.

10. The method of claim 1, wherein users comprising buyers express intent to join deals through the electronic marketplace.

11. The method of claim 10, wherein users comprising sellers view expressions of intent to join deals by users comprising buyers.

12. The method of claim 10, wherein users comprising buyers who have expressed intent to join a deal are able to join such deal after the deal has been accepted by a user comprising a seller.

13. The method of claim 1, wherein each user is able, through the provided electronic marketplace, to promote a proposed deal on a social networking site at which the buyer has an account.

14. The method of claim 1, wherein each user is able, through the provided electronic marketplace, to send information about a proposed deal by email.

15. The method of claim 1, wherein a user proposes a deal by creating a deal, comprising the steps of:
(a) specifying both a minimum number of users comprising buyers who must join the deal in order for deal to be accepted and a maximum number of users comprising buyers who may join the deal in order for the deal to be accepted;
(b) specifying an expiration date of the deal;
(c) specifying a category associated with a good or service of the deal;
(d) specifying a branded good or service of the deal;
(e) specifying a geographical area in which a good or service of the deal is limited;
(f) specifying a retail value of a good or service of the deal;
(g) specifying a discount to a retail value of a good or service of the deal;
(h) specifying tiered discounts based on the number of users comprising buyers who have joined the deal;
(i) specifying an immediate sale price of a good or service of the deal;
(j) specifying users comprising sellers for soliciting acceptance of the deal;
(k) specifying whether unspecified sellers are permitted to accept the deal; and
(l) any combination of the foregoing.

16-20. (canceled)

21. A method for buyer-initiated deal making, comprising:
(a) receiving, via electronic communications, data representative of a proposed deal, to buy one or more goods or services, entered by a first registered user of a deal making system via a graphical user interface of the deal making system, the first registered user being registered as a buyer, and the data representative of the proposed deal including data representative of
(i) the one or more goods or services, and
(ii) a bid corresponding to a price the first registered user is willing to pay for the one or more goods or services;
(b) displaying, via a graphical user interface of the deal making system, to a second registered user of the deal making system who is registered as a buyer, information regarding the proposed deal;
(c) receiving, via electronic communications, data representative of a commitment to the proposed deal entered by the second registered user of the deal making system via a graphical user interface of the deal making system;
(d) displaying, via a graphical user interface of the deal making system, to a third registered user of the deal making system who is registered as a seller, information regarding the proposed deal; and
(e) receiving, via electronic communications, data representative of seller acceptance of the proposed deal entered by the third registered user of the deal making system via a graphical user interface of the deal making system, seller acceptance indicating a willingness to provide the one or more goods or services at the price associated with the proposed deal.

22-28. (canceled)

29. The method of claim 21, wherein the step of displaying, via a graphical user interface of the deal making system, to a second registered user of the deal making system who is registered as a buyer, information regarding the proposed deal, comprises displaying the proposed deal in a deal feed interface which displays a plurality of proposed deals.

30. (canceled)

31. The method of claim 21, wherein the step of receiving, via electronic communications, data representative of a commitment to the proposed deal entered by the second registered user of the deal making system via a graphical user interface of the deal making system comprises receiving data representative of a soft commitment.

32. The method of claim 21, wherein the step of receiving, via electronic communications, data representative of a commitment to the proposed deal entered by the second registered user of the deal making system via a graphical user interface of the deal making system comprises receiving data representative of a hard commitment.

33-39. (canceled)

40. A method for buyer-initiated deal making, comprising:
(a) receiving, via electronic communications, data representative of a proposed deal, to buy one or more goods or services, entered by a first registered user of a deal making system via a graphical user interface of the deal making system, the first registered user being registered as a buyer, and the data representative of the proposed deal including data representative of,
(i) the one or more goods or services,
(ii) a bid corresponding to a price the first registered user is willing to pay for the one or more goods or services, and
(iii) a price for immediate sale which is lower than the bid;
(b) displaying, via a graphical user interface of the deal making system, to a second registered user of the deal making system who is registered as a buyer, information regarding the proposed deal;
(c) receiving, via electronic communications, data representative of a commitment to the proposed deal entered by the second registered user of the deal making system via a graphical user interface of the deal making system;
(d) displaying, via a graphical user interface of the deal making system, to a third registered user of the deal making system who is registered as a seller, information regarding the proposed deal;
(e) receiving, via electronic communications, data representative of seller willingness to provide the one or more goods or services at the bid price, entered by the third registered user of the deal making system via a graphical user interface of the deal making system;
(f) displaying, via a graphical user interface of the deal making system, to a fourth registered user of the deal making system who is registered as a seller, information regarding the proposed deal; and
(g) receiving, via electronic communications, data representative of seller willingness to provide the one or more goods or services at the price for immediate sale, entered by the fourth registered user of the deal making system via a graphical user interface of the deal making system.

41-50. (canceled)
